(19) United States
(12) Patent Application Publication
(10) Pub. No.: US 2007/0217042 A1
(43) Pub. Date: Sep. 20, 2007

(54) Rectilinear Mirror and Imaging System Having the Same

(75) Inventor: Gyeong-Il Kweon, Gwangju (KR)

Correspondence Address: IPLA P.A., 3580 WILSHIRE BLVD., 17TH FLOOR, LOS ANGELES, CA, 90010, US

(73) Assignee: Prefix Suffix

(21) Appl. No.: 11/574,132

(22) PCT Filed: Oct. 14, 2005
(86) PCT No.: PCT/KR05/03446

§ 371 Date: Feb. 22, 2007

(30) Foreign Application Priority Data
Oct. 14, 2004 (KR) 10-2004-0084605
Feb. 7, 2005 (KR) 10-2005-0011354

(51) Int. Cl. G02B 5/10

(52) U.S. Cl. 359/850; 359/838

(57) ABSTRACT

The present invention has been proposed to provide rectilinear mirrors having wide field of view comparable to those of fisheye lenses without worsening the distortion aberration, and imaging systems having the same.

### TECHNICAL FIELD

The present invention generally relates to a catadioptric imaging system, and more particularly to catadioptric imaging system having a wide field of view and minimizing distortion aberration.

### BACKGROUND ART

A panoramic imaging system is an imaging system providing images of every direction (i.e., 360°) in one photograph. In this respect, a panoramic camera is interpreted as an imaging system capable of taking 360° view from a given position.

On the other hand, an omni-directional imaging system captures the view of every possible direction from a given position. Thus, an omni-directional imaging system shows a view that a person could observe from a given position by turning around and looking up and down. Mathematically speaking, the region imaged by the omnidirectional imaging system has a solid angle of 4π steradian.

There have been a lot of studies and developments of panoramic imaging systems in order to photograph buildings, nature scenes, heavenly bodies and so on. Recently, more vigorous studies are undertaken in order to apply panoramic imaging systems in various fields such as security/surveillance systems using charge-coupled device (CCD) cameras, virtual tour systems providing images of real estates, hotels and tourist resorts, navigational aids for mobile robots and unmanned vehicles.

A panoramic imaging system or a wide-angle imaging system can be easily embodied using a fisheye lens with a wide field of view (FOV). The whole sky and the horizon can be taken in a single image using a camera equipped with a fisheye lens having a FOV larger than 180° by pointing the camera toward the zenith (i.e., the optical axis of the camera is aligned perpendicular to the ground). On this reason, fisheye lenses have been often referred to as “all-sky lenses”. Particularly, a high-end fisheye lens by Nikon, namely, 6 mm f/5.6 Fisheye-Nikkor, has a FOV of 220°. A camera equipped with this lens can capture images of the rear side of the camera as well as the forward side of the camera. However, fisheye lenses cannot be easily adapted to mobile robots and security/surveillance systems because fisheye lenses are large, heavy and expensive. Further, a fisheye lens intentionally induces barrel distortion in order to obtain a wide FOV. In effects, straight lines are not imaged as straight lines if the lines do not go through the centre of the image. Therefore, an image captured with a fisheye lens is perspectively wrong, different from the real scene, and gives an unpleasant feeling to the user.

A special class of wide-angle lens called rectilinear lens exists which exhibits a minimum amount of distortion aberration and hence images straight lines as straight.

However, similar to fisheye lenses, rectilinear lenses are also large, heavy and expensive. Furthermore, by technological reasons, the FOV of rectilinear lenses cannot be larger than 140°. Therefore, it is not desirable to employ rectilinear lenses in implementing panoramic or omni-directional imaging systems.

To overcome the aforementioned problems, catadioptric imaging systems employing both mirrors and refractive lenses have been actively researched. FIG. 1 illustrates the rectilinear wide-angle imaging system of a prior art employing a convex mirror (see R. A. Hicks, R. Bajcsy, “Reflective surfaces as computational sensors,” Image and Vision Computing, vol. 19, pp. 773-777, 2001).

Referring to FIG. 1, the surface profile of the rectilinear mirror 101 of a prior art usable in a catadioptric imaging system 100 is illustrated. The mirror surface 101 has a rotationally symmetric profile about the rotational symmetry axis 103. The rotational symmetry axis 103 is perpendicular to the ground (reference plane) 105 at the intersection point O. A camera (not shown) equipped with an image sensor 107 is arranged to face the mirror surface 101, and the optical axis of the camera coincides with the rotational symmetry axis 103. The nodal point N of the camera is located at a predetermined distance from the bottom (i.e., the lowest point) of the mirror surface 101. A nodal point is the position of the pinhole when a camera is approximated as an ideal pinhole camera. Generally, the nodal point is located within the lens barrel of a camera. The distance between the camera nodal point N and the image sensor 107 is approximately equal to the camera focal length f. Furthermore, the image sensor 107 is located at a predetermined height h from the ground 105.

Hereinafter, a ray before the reflection at the mirror surface will be designated as an incident ray, and a ray after the reflection at the mirror as a reflected ray. In such an imaging system, an incident ray originating from a point P on the object 111 lying on the reference plane 105 is reflected at a point M on the mirror surface 101, and as a reflected ray 115, passes through the nodal point N of the camera lens and is captured by the image sensor 107.

Due to the rotationally symmetric structure, the profile of the mirror surface can be conveniently described in a cylindrical coordinate having the rotational symmetry axis 103 as the z-axis. Furthermore, the intersection O between the rotational symmetry axis 103 and reference plane 105 is used as the origin of the cylindrical coordinate.

Hereinafter, a distance measured perpendicular to the rotational symmetry axis is designated as a radius (i.e., more precisely as an axial radius), and the distance measured parallel to the rotational symmetry axis is designated as a height. Therefore, the radius of the pixel in the image sensor that were hit by the reflected ray 115 is x, the radius of the point M on the mirror surface 101 has a radius t(x) and the point P on the object 111 has a radius d(x). The normal 119 of the tangent plane to the mirror surface 101 at the point M subtends an angle θ with the vertical line 117 perpendicularly drawn to the reference plane 105 from the point M. Furthermore, an incident ray 113 propagating toward the point M and the normal 119 subtends an angle ψ, and a reflected ray reflected from the point M on the mirror surface subtends an angle φ with the vertical line 117. The rotational symmetry axis 103, the vertical line 117, the normal 119, the incident ray 113 and the reflected ray 115 are coplanar (i.e., all in the same plane).

In accordance with the well-known specular law of reflection, the incidence angle ψ is equal to the reflection angle (φ+θ) as shown in the following Equation 1.
φ+θ=ψ MathFigure 1

In the Equation 1 and all the other equations to be followed hereinafter, radian is used as the unit of angle. The following Equation 2 can be obtained by adding θ to both sides of the Equation 1.
φ+2θ=ψ+θ MathFigure 2

Equation 3 follows by taking the tangent of Equation 2 and employing the geometrical relations schematically shown in FIG. 1.

$$tan ( ϕ + 2 θ ) = tan ( ψ + θ ) = \frac{d ( x ) - t ( x )}{F ( t ( x ) )} \qquad MathFigure 3$$

In the Equation 3, F(t(x)) is the profile of the mirror surface 101 given in terms of the height from the reference plane 105 to an arbitrary point M on the mirror surface 101 as a function of the radius t(x) of the point M, and given as the following Equation 4.

$$F ( t ( x ) ) = f + h + \frac{f}{x} t ( x ) \qquad MathFigure 4$$

On the other hand, the tangent of the angle φ is the radius x, which is the distance from the symmetry axis 103 to the pixel hit by the reflected ray, divided by the focal length f of the camera lens as shown in the following Equation 5.

$$tan ϕ = \frac{x}{f} \qquad MathFigure 5$$

Therefore, the following Equation 6 can be obtained from the tangent sum rule.

$$tan ( ϕ + 2 θ ) = \frac{( x / f ) + tan ( 2 θ )}{1 - ( x / f ) tan ( 2 θ )} \qquad MathFigure 6$$

Also, the tangent of the angle θ is the derivative of the mirror profile at the point M.

$$tan θ = \frac{ⅆ F ( t )}{ⅆ t} ≡ {F}^{′} ( t ) \qquad MathFigure 7$$

The prime symbol denotes a differentiation with respect to t, and the following Equation 8 is also obtained from the tangent sum rule.

$$tan ( 2 θ ) = \frac{2 {F}^{′} ( t )}{1 - {( {F}^{′} ( t ) )}^{2}} \qquad MathFigure 8$$

Therefore, the following Equation 9 can be obtained from the Equations 3 and 8.

$$\frac{\frac{x}{f} + \frac{2 {F}^{′} ( t )}{1 - {( {F}^{′} ( t ) )}^{2}}}{1 - \frac{x}{f} \frac{2 {F}^{′} ( t )}{1 - {( {F}^{′} ( t ) )}^{2}}} = \frac{d ( x ) - t ( x )}{F ( t ( x ) )} \qquad MathFigure 9$$

By solving the nonlinear differential equation given in the Equation 9, the profile F(t(x)) of the mirror surface can be obtained. To solve this differential equation, the functional relation between x and d(x) must be provided. The designation of the valid range of x and the functional relation d(x) corresponds to a design of the mirror surface.

Ideally, it is desirable that d(x) is directly proportional to x, i.e., d(x)=ax (here, ‘a’ is a constant). However, the nonlinear differential equation cannot be solved in this case.

Therefore, a linear relation given in the Equation 10 is used instead to solve the Equation 9.
d(x)=ax+b MathFigure 10

In the Equation 10, ‘a’ and ‘b’ are both constants, and if the constant b is very small, the linear relation given in the Equation 10 approaches the ideal projection scheme, namely d(x)=ax.

The imaging system of the prior art having a rectilinear or a rectifying mirror as described above provides a satisfactory image only at a predetermined height h from the reference plane (see R. A. Hicks, “Rectifying mirror”, U.S. Pat. No. 6,412,961 B1). Namely, in order to rigorously realize the projection scheme given in the Equation 10 and hence acquire a distortion-free image, the imaging system should be set up at a height h, where the value h has been fixed during the fabrication of the rectifying mirror.

In a case where the imaging system of the prior art is installed at a place for security/surveillance purpose, such as in a convenience store, a bank, and an office, it is desirable to set up the imaging system at the center of the ceiling. In general, however, ceilings of different buildings will have different heights. Therefore, for the imaging system to be widely employed in various places, either the rectifying mirror should be custom-made for each ceiling of a given height, or different kinds of mirrors suitable for different ceiling heights should be kept in stock as if there are ready-made shirts and pants of different sizes. However, the former method cost much time and money in fabricating a custom mirror for each individual order, and the latter method is also costly, particularly due to the need in preparing many different precision molds. When the idea of using an optimum mirror for a given ceiling height is given up due to the excessive cost, then a mirror designed for one particular ceiling height should be used for all the ceilings of different heights. In this case, the obtained image will not be satisfactory much like the case of wearing a wrong-sized outfit.

To make matters worse, the aforementioned problem still persist even when an optimum mirror custom-made for a specific ceiling height is used. In a room that is desired to be monitored by a security camera, there will be many different objects and people with varying heights. Therefore, an imaging system with a rectifying mirror which has been designed for a specific ceiling height h will inevitably induces an image distortion for objects and people with non-zero heights. Therefore, an imaging system with a rectifying mirror designed for a specific height cannot help but inducing image distortions for any real situations.

For an imaging system employing the rectifying mirror described by the Equation 9, it is not clear what are the angular ranges of the incident and the reflected rays (i.e., the FOV of the imaging system as a whole and the FOV of the refractive lens that has to be used in conjunction with the rectifying mirror).

As has been mentioned above, the mirror profile of the imaging system of the prior art is given as a solution of the Equation 9. Since it is a non-linear differential equation, it is usually very difficult to obtain an exact analytical solution. Obtaining a numerical solution using numerical analysis technique is also a paramount task due to the non-linear nature of the equation. Therefore the solution of the Equation 9 is difficult to obtain for a researcher whose research expertise is not numerical analysis.

A stereovision (or a stereoscopic vision) is one of the fields in computer vision seeking to mimic the ability of a creature with a binocular vision to retrieve threedimensional distance information. A three-dimensional shape measurement is basically a task for assigning distance information to all pixels corresponding to the captured objects. Therefore, distance measurement, i.e., ranging, is the central technology in a stereovision system.

FIG. 2 is a schematic diagram illustrating a stereovision system 200 in accordance with another prior art. As shown in FIG. 2, the most common method of embodying a stereovision system 200 is employing two cameras 201 and 202 with identical specifications that are laterally disposed with an interval D and pointing the same direction (i.e., optical axes OX₁ and OX₂ of the two cameras are parallel to each other). In other words, the nodal points N₁ and N₂ of the two cameras are set apart from each other with an interval D and a line connecting the two nodal points N₁ and N₂ is perpendicular to the optical axes of the two cameras. Depending on the purpose of the application, the interval D can be set similar to a distance between the eyes of an average human.

To retrieve the distance information of an object with the stereovision system 200, the object must be captured by both the left camera 201 and the right camera 202.

Then, a specific point P of the object is selected from the left and the right images captured by the two cameras. More specifically, a pixel corresponding to the specific point P is found from the left image taken by the left camera 201, and the corresponding pixel is found from the right image taken by the right camera 202. Numerous technologies are employed for finding the matching pair of pixels corresponding to a given point P. Once a matching pair of pixels corresponding to the point P are found, angles θ₁ and θ₂ between the point P and the optical axes OX₁ and OX₂ of the two cameras 201 and 202 are computed based on the coordinates of the pixels. By using the two angles θ₁ and θ₂ and the interval D between the two nodal points N₁ and N₂ the three dimensional position information of the point P can be easily obtained from the basic technique of triangulation.

It is not necessarily mandatory to employ two cameras in constructing a stereovision system. For example, the screen of a single camera can be divided into left and right parts by means of a mirror or a bi-prism, thus allowing two separate images of the same object to be captured. However, the fundamental principle is the same as the method explained above.

Depending on the application fields, a panoramic stereovision system or a panoramic rangefinder may be necessary. In the field of security/surveillance, for instance, it will be very useful if distance information to a trespasser is available. Similarly, a panoramic stereovision system can be used by the military for monitoring mountain ranges, wilderness and coasts. In such cases, distance information to a potential invader is very important, because the invader who is far away from here is not really an invader, or at least a less threatening one. Further, a panoramic stereovision system can be also useful for navigational systems such as mobile robots, automobiles, unmanned vehicles and aircrafts. Especially, self-navigating modules such as unmanned vehicles should be equipped with a collision avoidance system, and consequently the distance to an obstacle must be computed swiftly and precisely. However, the conventional stereovision system as shown in FIG. 2 can detect and measure the distance to an obstacle for the forward side of the camera only. Accordingly, it is impossible for the conventional stereovision system to generate a warning message or take an appropriate preventive measure against an obstacle or a mobile system approaching from the side or from the rear.

The above-mentioned problem can be resolved by using a stereovision system comprising two panoramic mirrors and one or two cameras, as illustrated in FIGS. 3 to 7. However, for the stereovision systems shown in FIGS. 3 to 7, the camera 311 or 312 itself obstructs the view of the panoramic mirror 301 or 302. Furthermore, there exists an additional dead zone because one panoramic mirror partly occludes the view of the other panoramic mirror.

In addition to this, for the panoramic stereovision systems shown in FIGS. 5 to 7, the FOV and the mirror gain of the two panoramic mirrors are not identical. Due to this disparity in the FOV and the mirror gain, it is technically more difficult to realize an efficient panoramic stereovision system, and degradation of image resolution is inevitable.

### DISCLOSURE OF INVENTION

### Technical Problem

To overcome the problems mentioned above, the present invention has been proposed to provide rectilinear mirrors having wide field of view comparable to those of fisheye lenses without worsening the distortion aberration, and imaging systems having the same.

### TECHNICAL SOLUTION

In accordance with one aspect of the present invention, there is provided a mirror, comprising: a mirror surface having a rotationally symmetric profile about the z-axis in a spherical coordinate, wherein the z-axis has zero zenith angle, and the profile of the mirror surface is described with a set of coordinate pairs (θ, r(θ)) in the spherical coordinate, θ is the zenith angle of a reflected ray reflected at a first point on the mirror surface and passing through the origin of the spherical coordinate, the zenith angle θ ranges from zero to a maximum zenith angle θ₂ less than π/2 (0≦θ≦θ₂<π/2), and r(θ) is the corresponding distance from the origin of the spherical coordinate to the first point on the mirror surface and satisfies the following Equation 1,

$$r ( θ ) = r ( 0 ) exp [ {\int }_{0}^{θ} \frac{sin {θ}^{′} + cot ϕ ( {θ}^{′} ) cos {θ}^{′}}{cos {θ}^{′} - cot ϕ ( {θ}^{′} ) sin {θ}^{′}} ⅆ {θ}^{′} ] \qquad ( Equation 1 )$$

where r(0) is the distance from the origin to the intersection between the mirror surface and the z-axis, the first reflected ray is formed by an incident ray having a nadir angle δ ranging from zero to a maximum nadir angle δ₂ less than π/2 (0≦δ≦δ₂<π/2), the nadir angle δ is a function of the zenith angle θ and satisfies the following Equation 2,

$$δ ( θ ) = {tan}^{- 1} ( \frac{tan {δ}_{2}}{tan {θ}_{2}} tan θ ) \qquad ( Equation 2 )$$

and, φ(θ) is the angle subtended by the z-axis and the tangent plane to the mirror surface at the first point, and is a function of θ and δ(θ) as the following Equation 3.

$$ϕ ( θ ) = \frac{θ + π \pm δ ( θ )}{2} \qquad ( Equation 3 )$$

In accordance with another aspect of the present invention, there is provided a panoramic mirror, comprising: a mirror surface having a rotationally symmetric profile about the z-axis in a spherical coordinate, wherein the z-axis has zero zenith angle, and the profile of the mirror surface is described with a set of coordinate pairs (θ, r(θ)) in the spherical coordinate, θ is the zenith angle of a first reflected ray reflected at a first point on the mirror surface and passing through the origin of the spherical coordinate, the zenith angle θ ranges from a minimum zenith angle θ₁ larger than zero to a maximum zenith angle θ₂ less than π/2 (0<θ₁≦θ≦θ₂<π/2), and r(θ) is the corresponding distance from the origin of the spherical coordinate to the first point on the mirror surface and satisfies the following Equation 4,

$$r ( θ ) = r ( {θ}_{i} ) exp [ {\int }_{{θ}_{i}}^{θ} \frac{sin {θ}^{′} + cot ϕ ( {θ}^{′} ) cos {θ}^{′}}{cos {θ}^{′} - cot ϕ ( {θ}^{′} ) sin {θ}^{′}} ⅆ {θ}^{′} ] \qquad ( Equation 4 )$$

where θᵢ is the zenith angle of a second reflected ray reflected at a second point on the mirror surface and passing through the origin of the spherical coordinate, and r(θᵢ) is the corresponding distance from the origin to the second point, a normal drawn from the first point to a cone compassing the mirror surface and having the rotational symmetry axis coinciding with the z-axis has an altitude angle ψ, where the altitude angle ψ is measured from the plane perpendicular to the z-axis (i.e., the x-y plane) toward the zenith, the first reflected ray is formed by an incident ray having an elevation angle μ, the elevation angle μ is measured from the normal to the incident ray in the same direction as the altitude angle ψ, both the altitude and the elevation angles are bounded between −π/2 and π/2, the elevation angle μ is a function of the zenith angle θ as the following Equation 5,

$$μ ( θ ) = {tan}^{- 1} [ \frac{tan {μ}_{2} - tan {μ}_{1}}{tan {θ}_{2} - tan {θ}_{1}} ( tan θ - tan {θ}_{1} ) + tan {μ}_{1} ] \qquad ( Equation 5 )$$

and φ(θ) is the angle subtended by the z-axis and the tangent plane to the mirror surface at the first point, and is a function of the zenith angle θ and the elevation angle μ(θ) as the following Equation 6.

$$ϕ ( θ ) = \frac{θ + \frac{π}{2} - ψ - μ ( θ )}{2} \qquad ( Equation 6 )$$

In accordance with another aspect of the present invention, there is provided a folded panoramic mirror, comprising: a first mirror including a curved mirror surface having a rotationally symmetric profile about a rotational symmetry axis, wherein the curved mirror surface extends from a first inner hoop having a radius ρ₁ to a first outer hoop having a radius ρ₂ and the first mirror has a circular hole inside of the inner hoop; and a second mirror including a planar mirror surface facing the curved mirror surface, wherein the planar mirror has a ring shape defined with a second inner hoop having a radius ρ_{I} and a second outer hoop having a radius ρ_{O}, wherein all the radii of the first inner hoop, the second inner hoop, the first outer hoop and the second outer hoop are measured in a direction normal to the rotational symmetry axis, the first mirror and the second mirror share the same rotational symmetry axis, the curved mirror surface is described with a set of coordinate pairs (θ, r(θ)) in a spherical coordinate having the rotational symmetry axis as the z-axis, wherein θ is the zenith angle of a first reflected ray reflected at a first point on the curved mirror surface and passing through the origin of the spherical coordinate, the zenith angle of the z-axis is zero, the zenith angle θ ranges from a minimum zenith angle θ₁ larger than zero to a maximum zenith angle θ₂ less than π/2(0<θ₁≦θ≦θ₂<π/2), and r(θ) is the corresponding distance from the origin of the spherical coordinate to the first point on the curved mirror surface and satisfies the following Equation 7,

$$r ( θ ) = r ( {θ}_{i} ) exp [ {\int }_{{θ}_{i}}^{θ} \frac{sin {θ}^{′} + cot ϕ ( {θ}^{′} ) cos {θ}^{′}}{cos {θ}^{′} - cot ϕ ( {θ}^{′} ) sin {θ}^{′}} ⅆ {θ}^{′} ] \qquad ( Equation 7 )$$

where θᵢ is the zenith angle of a second reflected ray reflected at a second point on the curved mirror surface and passing through the origin of the spherical coordinate, and r(θᵢ) is the corresponding distance from the origin to the second point, the radius ρ₁ of the first inner hoop is determined as Equation 8,
ρ₁=r(θ₁)sin θ₁ (Equation 8)

the radius ρ₂ of the first outer hoop is determined as Equation 9,
ρ₂=r(θ₂)sin θ₂ (Equation 9)

a normal drawn from the first point to a cone compassing both the curved mirror and the planar mirror and having the rotational symmetry axis coinciding with the z-axis has an altitude angle ψ, the altitude angle ψ is measured from the plane perpendicular to the z-axis (i.e., the x-y plane) toward the zenith, the first reflected ray is formed by a first incident ray having an elevation angle μ, where the elevation angle μ is the angle measured from the normal to the incident ray in the same direction as the altitude angle ψ, the altitude angle ψ is bounded between −π/2 and π/2(π/2<ψ<π/2), the elevation angle μ ranges from a minimum elevation angle μ₁ larger than −π/2 to a maximum elevation angle μ₂ less than π/2 (−λ/2<μ₁≦μ≦μ₂<π/2), and the elevation angle μ is a function of the zenith angle θ as the following Equation 10,

$$μ ( θ ) = {tan}^{- 1} [ \frac{tan {μ}_{2} - tan {μ}_{1}}{tan {θ}_{2} - tan {θ}_{1}} ( tan θ - tan {θ}_{1} ) + tan {μ}_{1} ] \qquad ( Equation 10 )$$

and φ(θ) is the angle subtended by the z-axis and the tangent plane to the curved mirror surface at the first point, and is a function of the zenith angle θ and the elevation angle μ(θ) as the following Equation 11,

$$ϕ ( θ ) = \frac{θ + \frac{π}{2} - ψ - μ ( θ )}{2} \qquad ( Equation 11 )$$

the height z₁ from the origin to the first inner hoop of the curved mirror surface is determined as the following Equation 12,
z₁=r(θ₁)cos θ₁ (Equation 12)

the height from the origin to the planar mirror surface is equal to the smaller one between zₒ⁽¹⁾ given in the following Equation 13 and zₒ⁽²⁾ given in the following Equation 14 (zₒ=min(zₒ⁽¹⁾, zₒ⁽²⁾⁾),

$$\begin{matrix}{z}_{o}^{( 1 )} = \frac{{ρ}_{1} + {z}_{1} tan {θ}_{2}}{2 tan {θ}_{2}} and & ( Equation 13 ) \\ {z}_{o}^{( 2 )} = \frac{{ρ}_{1} - {z}_{1} cot ( ψ + {μ}_{1} )}{tan {θ}_{2} - cot ( ψ + {μ}_{1} )} & ( Equation 14 )\end{matrix}$$

the radius of the second inner hoop is set as no larger than ρ_{I} given in the following Equation 15,
ρ_{I}=zₒ tan θ₁ (Equation 15)

and the radius of the second outer hoop is set as no smaller than ρ_{O} given in the following Equation 16.
ρ_{O}=zₒ tan θ₂ (Equation 16)

In accordance with another aspect of the present invention, there is provided a double panoramic mirror, comprising: a first mirror surface and a second mirror surface respectively having a rotationally symmetric profile about the z-axis in a spherical coordinate, wherein the z-axis has zero zenith angle, and the profile of the first mirror surface is described with a set of coordinate pairs (θ_{I}, r_{I}(θ_{I})) in the spherical coordinate, θ_{I} is the zenith angle of a first reflected ray reflected at a first point on the first mirror surface and passing through the origin of the spherical coordinate, the zenith angle θ_{I} ranges from a minimum zenith angle θ_{I1} larger than zero to a maximum zenith angle θ_{I2} less than π/2 (0<θ_{I1}≦θ_{I}≦θ_{I2}<π/2), and r_{I}(θ_{I}) is the corresponding distance from the origin of the spherical coordinate to the first point on the first mirror surface and satisfies the following Equation 17,

$${r}_{I} ( {θ}_{I} ) = {r}_{I} ( {θ}_{Ii} ) exp [ {\int }_{{θ}_{Ii}}^{{θ}_{I}} \frac{sin {θ}^{′} + cot {ϕ}_{I} ( {θ}^{′} ) cos {θ}^{′}}{cos {θ}^{′} - cot {ϕ}_{I} ( {θ}^{′} ) sin {θ}^{′}} ⅆ {θ}^{′} ] \qquad ( Equation 17 )$$

where θ_{Ii} is the zenith angle of a second reflected ray reflected at a second point on the first mirror surface and passing through the origin of the spherical coordinate, and r_{I}(θ_{Ii}) is the corresponding distance from the origin to the second point, a normal drawn from the first point to a cone compassing both the first and the second mirror surfaces and having the rotational symmetry axis coinciding with the z-axis has an altitude angle ψ, the altitude angle ψ is measured from the plane perpendicular to the z-axis (i.e., the x-y plane) toward the zenith, the first reflected ray is formed by a first incident ray having an elevation angle μ_{I}, where the elevation angle μ_{I} is the angle subtended by the normal and the incident ray, the elevation angle μ_{I} is measured from the normal to the incident ray in the same direction as the altitude angle ψ, the altitude angle ψ is bounded between −π/2 and π/2(−π/2<ψ<π/2), the elevation angle μ_{I} ranges from a minimum elevation angle μ_{I1} larger than −π/2 to a maximum elevation angle μ_{I2} less than π/2 (−π/2<μ_{I1}≦μ_{I}≦μ_{I2}<π/2), and the elevation angle μ_{I} is a function of the zenith angle θ_{I} as the following Equation 18,

$$\begin{matrix}{μ}_{I} ( {θ}_{I} ) = {tan}^{- 1} [ \frac{tan {μ}_{I 2} - tan {μ}_{I 1}}{tan {θ}_{I 2} - tan {θ}_{I 1}} ( tan {θ}_{I} - tan {θ}_{I 1} ) + tan {μ}_{I 1} ] & ( Equation 18 ) \\ & \end{matrix}$$

and φ_{I}(θ_{I}) is the angle subtended by the z-axis and the first tangent plane to the first mirror surface at the first point, and is a function of the zenith angle θ_{I} and the elevation angle μ_{I}(θ_{I}) as the following Equation 19,

$$\begin{matrix}{ϕ}_{I} ( {θ}_{I} ) = \frac{{θ}_{I} + \frac{π}{2} - ψ - {μ}_{I} ( {θ}_{I} )}{2} & \\ & \end{matrix} \qquad ( Equation 19 )$$

the profile of the second mirror surface is described with a set of coordinate pairs (θ_{O}, r_{O}(θ_{O})) in the spherical coordinate, θ_{O} is the zenith angle of a third reflected ray reflected at a third point on the second mirror surface and passing through the origin of the spherical coordinate, the zenith angle θ_{O} ranges from a minimum zenith angle θ_{O1} no less than θ_{I2} to a maximum zenith angle θ_{O2} less than π/2 (θ_{I2}≦θ_{O1}≦θ_{O}≦θ_{O2}<π/2), and r_{O}(θ_{O}) is the corresponding distance from the origin of the spherical coordinate to the third point on the second mirror surface and satisfies the following Equation 20,

$${r}_{o} ( {θ}_{o} ) = {r}_{o} ( {θ}_{oi} ) exp [ {\int }_{{θ}_{oi}}^{{θ}_{o}} \frac{sin {θ}^{′} + cot {ϕ}_{o} ( {θ}^{′} ) cos {θ}^{′}}{cos {θ}^{′} - cot {ϕ}_{o} ( {θ}^{′} ) sin {θ}^{′}} ⅆ {θ}^{′} ] \qquad ( Equation 20 )$$

where θ_{Oi} is the zenith angle of a fourth reflected ray reflected at a fourth point on the second mirror surface and passing through the origin of the spherical coordinate and r_{O}(θ_{Oi}) is the corresponding distance from the origin to the fourth point, the third reflected ray is formed by a second incident ray having a second elevation angle μ_{O} measured from the normal toward the zenith, the elevation angle μ_{O} ranges from μ_{O1} larger than π/2 to μ_{O2} less than π/2 (−π/2<μ_{O1}≦μ_{O}≦μ_{O2}<π/2), and the elevation angle μ_{O} is a function of the zenith angle θ_{O} as the following Equation 21,

$${μ}_{O} ( {θ}_{O} ) = {tan}^{- 1} [ \frac{tan {μ}_{O 2} - tan {μ}_{O 1}}{tan {θ}_{O 2} - tan {θ}_{O 1}} ( tan {θ}_{O} - tan {θ}_{O 1} ) + tan {μ}_{O 1} ] \qquad ( Equation 21 )$$

and φ_{O}(θ_{O}) is the angle subtended by the z-axis and the second tangent plane to the second mirror surface at the third point, and is a function of the zenith angle θ_{O} and the elevation angle μ_{O}(θ_{O}) as the following Equation 22.

$${ϕ}_{O} ( {θ}_{O} ) = \frac{{θ}_{O} + \frac{π}{2} - ψ - {μ}_{O} ( {θ}_{O} )}{2} \qquad ( Equation 22 )$$

In accordance with another aspect of the present invention, there is provided a complex mirror, comprising: a first mirror surface and a second mirror surface respectively having a rotationally symmetric profile about the z-axis in a spherical coordinate, wherein the z-axis has zero zenith angle, and the profile of the first mirror surface is described with a set of coordinate pairs (θ_{I}, r_{I}(θ_{I})) in the spherical coordinate, θ_{I} is the zenith angle of a first reflected ray reflected at a first point on the first mirror surface and passing through the origin of the spherical coordinate, the zenith angle θ_{I} ranges from zero to a maximum zenith angle θ_{I2} less than π/2(0≦θ_{I}≦θ_{I2}<π/2), and r_{I}(θ_{I}) is the corresponding distance from the origin of the spherical coordinate to the first point on the first mirror surface and satisfies the following Equation 23,

$${r}_{I} ( {θ}_{I} ) = {r}_{I} ( 0 ) exp [ {\int }_{0}^{{θ}_{I}} \frac{sin {θ}^{′} + cot {ϕ}_{I} ( {θ}^{′} ) cos {θ}^{′}}{cos {θ}^{′} - cot {ϕ}_{I} ( {θ}^{′} ) sin {θ}^{′}} ⅆ {θ}^{′} ] \qquad ( Equation 23 )$$

where r_{I}(0) is the corresponding distance from the origin to the intersection between the first mirror surface and the z-axis, the first reflected ray is formed by a first incident ray having a nadir angle δ_{I} ranging from zero to a maximum nadir angle δ_{I2} less than π/2 (0≦δ_{I}≦δ_{I2}<π/2), the nadir angle δ_{I} is a function of the zenith angle θ_{I} having a maximum zenith angle θ_{I2} less than the maximum nadir angle δ_{I2}(0<θ_{I2}<δ_{I2}<π/2), and satisfies the following Equation 24,

$${δ}_{I} ( {θ}_{I} ) = {tan}^{- 1} ( \frac{tan {δ}_{I 2}}{tan {θ}_{I 2}} tan {θ}_{I} ) \qquad ( Equation 24 )$$

φ_{I}(θ_{I}) is the angle subtended by the z-axis and the first tangent plane to the first mirror surface at the first point, and is a function of θ_{I} and δ_{I}(θ_{I}) as the following Equation 25,

$${ϕ}_{I} ( {θ}_{I} ) = \frac{{θ}_{I} + ( π \pm {δ}_{I} )}{2} \qquad ( Equation 25 )$$

the profile of the second mirror surface is described with a set of coordinate pairs (θ_{O}, r_{O}(θ_{O})) in the spherical coordinate, θ_{O} is the zenith angle of a second reflected ray reflected at a second point on the second mirror surface and passing through the origin of the spherical coordinate, the zenith angle θ_{O} ranges from a minimum zenith angle θ_{O1} no less than θ_{I2} to a maximum zenith angle θ_{O2} less than π/2 (θ_{I2}≦θ_{O1}≦θ_{O}≦θ_{O2}<π/2), and r_{O}(θ_{O}) is the corresponding distance from the origin of the spherical coordinate to the second point on the second mirror surface and satisfies the following Equation 26,

$${r}_{o} ( {θ}_{o} ) = {r}_{0} ( {θ}_{oi} ) exp [ {\int }_{{θ}_{oi}}^{{θ}_{o}} \frac{sin {θ}^{′} + cot {ϕ}_{o} ( {θ}^{′} ) cos {θ}^{′}}{cos {θ}^{′} - cot {ϕ}_{o} ( {θ}^{′} ) sin {θ}^{′}} ⅆ {θ}^{′} ] \qquad ( Equation 26 )$$

where θ_{Oi} is the zenith angle of a third reflected ray reflected at a third point on the second mirror surface and passing through the origin of the spherical coordinate, and r_{O}(θ_{Oi}) is the corresponding distance from the origin to the third point, a normal drawn from the second point to a cone compassing both the first and the second mirror surfaces and having the rotational symmetry axis coinciding with the z-axis has an altitude angle ψ, the altitude angle ψ is measured from the plane perpendicular to the z-axis (i.e., the x-y plane) toward the zenith, the second reflected ray is formed by a second incident ray having an elevation angle μₒ, the elevation angle μₒ is measured from the normal to the incident ray in the same direction as the altitude angle ψ and ranges from a minimum elevation angle μ_{O1} larger than −π/2 to a maximum elevation angle μ_{O2} less than π/2 (−π/2<μ_{O1}≦μ_{O}≦μ_{O2}<π/2), and the elevation angle μ_{O} is a function of the zenith angle θ_{O} as the following Equation 27,

$${μ}_{O} ( {θ}_{O} ) = {tan}^{- 1} [ \frac{tan {μ}_{O 2} - tan {μ}_{O 1}}{tan {θ}_{O 2} - tan {θ}_{O 1}} ( tan {θ}_{O} - tan {θ}_{O 1} ) + tan {μ}_{O 1} ] \qquad ( Equation 27 )$$

and φ_{O}(θ_{O}) is the angle subtended by the z-axis and the second tangent plane to the second mirror surface at the second point, and is a function of the zenith angle θ_{O} and the elevation angle μ_{O}(θ_{O}) as the following Equation 28.

$${ϕ}_{o} ( {θ}_{o} ) = \frac{{θ}_{o} + \frac{π}{2} - ψ - {μ}_{o} ( {θ}_{o} )}{2} \qquad ( Equation 28 )$$

In accordance with another aspect of the present invention, there is provided an imaging system, comprising: a mirror including a mirror surface having a rotationally symmetric profile about the z-axis in a spherical coordinate, where the z-axis has zero zenith angle, and an image capturing means having an optical axis and a nodal point, wherein the image capturing means and the mirror surface are arranged so that the mirror surface is within the view of the image capturing means, wherein the profile of the mirror surface is described with a set of coordinate pairs (θ, r(θ)) in the spherical coordinate, θ is the zenith angle of a reflected ray reflected at a first point on the mirror surface and passing through the origin of the spherical coordinate, the zenith angle θ ranges from zero to a maximum zenith angle θ₂ less than π/2 (0≦θ≦θ₂<π/2), and r(θ) is the corresponding distance from the origin of the spherical coordinate to the first point on the mirror surface and satisfies the following Equation 29,

$$r ( θ ) = r ( 0 ) exp [ {\int }_{0}^{θ} \frac{sin {θ}^{′} + cot ϕ ( {θ}^{′} ) cos {θ}^{′}}{cos {θ}^{′} - cot ϕ ( {θ}^{′} ) sin {θ}^{′}} ⅆ {θ}^{′} ] \qquad ( Equation 29 )$$

where r(0) is the distance from the origin to the intersection between the mirror surface and the z-axis, the first reflected ray is formed by an incident ray having a nadir angle δ ranging from zero to a maximum nadir angle δ₂ less than π/2 (0≦δ≦δ₂<π/2), the nadir angle δ is a function of the zenith angle θ and satisfies the following Equation 30,

$$δ ( θ ) = {tan}^{- 1} ( \frac{tan {δ}_{2}}{tan {θ}_{2}} tan θ ) \qquad ( Equation 30 )$$

φ(θ) is the angle subtended by the z-axis and the tangent plane to the mirror surface at the first point, and is a function of θ and φ(θ) as the following Equation 31,

$$ϕ ( θ ) = \frac{θ + π \pm δ ( θ )}{2} \qquad ( Equation 31 )$$

the optical axis of the image capturing means coincides with the z-axis, and the nodal point of the image capturing means is located at the origin of the spherical coordinate.

In accordance with an aspect of the present invention, there is provided a catadioptric panoramic imaging system, comprising: a mirror including a mirror surface having a rotationally symmetric profile about the z-axis in a spherical coordinate, wherein the z-axis has zero zenith angle, and an image capturing means having an optical axis and a nodal point, wherein the image capturing means and the mirror surface are arranged so that the mirror surface is within the view of the image capturing means, and the profile of the mirror surface is described with a set of coordinate pairs (θ, r(θ)) in the spherical coordinate, θ is the zenith angle of a first reflected ray reflected at a first point on the mirror surface and passing through the origin of the spherical coordinate, the zenith angle θ ranges from a minimum zenith angle θ₁ larger than zero to a maximum zenith angle θ₂ less than π/2 (0<θ₁≦θ≦θ₂<π/2), and r(θ) is the corresponding distance from the origin of the spherical coordinate to the first point on the mirror surface and satisfies the following Equation 32,

$$r ( θ ) = r ( {θ}_{i} ) exp [ {\int }_{{θ}_{i}}^{θ} \frac{sin {θ}^{′} + cot ϕ ( {θ}^{′} ) cos {θ}^{′}}{cos {θ}^{′} - cot ϕ ( {θ}^{′} ) sin {θ}^{′}} ⅆ {θ}^{′} ] \qquad ( Equation 32 )$$

where θᵢ is the zenith angle of a second reflected ray reflected at a second point on the mirror surface and passing through the origin of the spherical coordinate, and r(θᵢ) is the corresponding distance from the origin to the second point, a normal drawn from the first point to a cone compassing the mirror surface and having the rotational symmetry axis coinciding with the z-axis has an altitude angle ψ, the altitude angle ψ is measured from the plane perpendicular to the z-axis (i.e., the x-y plane) toward the zenith, the first reflected ray is formed by an incident ray having an elevation angle μ, where the elevation angle μ is the angle subtended by the normal and the incident ray, the elevation angle μ is measured from the normal to the incident ray in the same direction as the altitude angle ψ, the altitude angle ψis bounded between −π/2 and π/2 (−π/2<ψ<π/2), the elevation angle μ ranges from μ₁ larger than −π/2 to μ₂ less than π/2 (−π/2<μ₁≦μ>μ₂<π/2), and the elevation angle μ is a function of the zenith angle θ as the following Equation 33,

$$μ ( θ ) = {tan}^{- 1} [ \frac{tan {μ}_{2} - tan {μ}_{1}}{tan {θ}_{2} - tan {θ}_{1}} ( tan θ - tan {θ}_{1} ) + tan {μ}_{1} ] \qquad ( Equation 33 )$$

φ(θ) is the angle subtended by the z-axis and the tangent plane to the mirror surface at the first point, and is a function of the zenith angle θ and the elevation angle μ(θ) as the following Equation 34,

$$ϕ ( θ ) = \frac{θ + \frac{π}{2} - ψ - μ ( θ )}{2} \qquad ( Equation 34 )$$

the optical axis of the image capturing means coincides with the z-axis, and the nodal point of the image capturing means is located at the origin of the spherical coordinate.

In accordance with another aspect of the present invention, there is provided a folded catadioptric panoramic imaging system, comprising: a first mirror including a curved mirror surface having a rotationally symmetric profile about a rotational symmetry axis, wherein the curved mirror surface extends from a first inner hoop having a radius ρ₁ to a first outer hoop having a radius ρ₂, and the first mirror has a circular hole inside of the inner hoop; a second mirror including a planar mirror surface facing the curved mirror surface, wherein the planar mirror has a ring shape defined with a second inner hoop having a radius ρ_{I} and a second outer hoop having a radius ρ_{O}; and an image capturing means having an optical axis and a nodal point, wherein the image capturing means and the mirror surfaces are arranged so that the planar mirror surface is within the view of the image capturing means, wherein all the radii of the first inner hoop, the second inner hoop, the first outer hoop and the second outer hoop are measured in a direction normal to the rotational symmetry axis, the first mirror and the second mirror share the same rotational symmetry axis coinciding with the optical axis of the image capturing means, the curved mirror surface is described with a set of coordinate pairs (θ, r(θ)) in a spherical coordinate having the rotational symmetry axis as the z-axis, wherein θ is the zenith angle of a first reflected ray reflected at a first point on the curved mirror surface and passing through the origin of the spherical coordinate, the zenith angle of the z-axis is zero, the zenith angle θ ranges from a minimum zenith angle θ₁ larger than zero to a maximum zenith angle θ₂ less than π/2 (0<θ₁≦θ≦θ₂<π/2), and r(θ) is the corresponding distance from the origin of the spherical coordinate to the first point on the curved mirror surface and satisfies the following Equation 35,

$$r ( θ ) = r ( {θ}_{i} ) exp [ {\int }_{{θ}_{i}}^{θ} \frac{sin {θ}^{′} + cot ϕ ( {θ}^{′} ) cos {θ}^{′}}{cos {θ}^{′} - cot ϕ ( {θ}^{′} ) sin {θ}^{′}} ⅆ {θ}^{′} ] \qquad ( Equation 35 )$$

where θᵢ is the zenith angle of a second reflected ray reflected at a second point on the curved mirror surface and passing through the origin of the spherical coordinate, and r(θᵢ) is the distance from the origin to the second point, the radius ρ₁ of the first inner hoop is determined as the following Equation 36,
ρ₁=r(θ₁)sin θ₁ (Equation 36)

the radius ρ₂ of the first outer hoop is determined as the following Equation 37,
ρ₂=r(θ₂)sin θ₂ (Equation 37)

a normal drawn from the first point to a cone compassing both the curved mirror and the planar mirror and having the rotational symmetry axis coinciding with the z-axis has an altitude angle ψ, the altitude angle ψ is measured from the plane perpendicular to the z-axis (i.e., the x-y plane) toward the zenith, the first reflected ray is formed by a first incident ray having an elevation angle μ where the elevation angle μ is the angle measured from the normal to the incident ray in the same direction as the altitude angle ψ, the altitude angle ψ is bounded between −π/2 and π/2(−π/2<ψ<π/2), the elevation angle μ ranges from a minimum elevation angle μ₁ larger than −π/2 to a maximum elevation angle μ₂ less than π/2 (−π/2<μ₁≦μ≦μ₂<π/2), and the elevation angle μ is a function of the zenith angle θ as the following Equation 38,

$$μ ( θ ) = {tan}^{- 1} [ \frac{tan {μ}_{2} - tan {μ}_{1}}{tan {θ}_{2} - tan {θ}_{1}} ( tan θ - tan {θ}_{1} ) + tan {μ}_{1} ] \qquad ( Equation 38 )$$

and φ(θ) is the angle subtended by the z-axis and the tangent plane to the curved mirror surface at the first point, and is a function of the zenith angle θ and the elevation angle μ(θ) as the following Equation 39,

$$ϕ ( θ ) = \frac{θ + \frac{π}{2} - ψ - μ ( θ )}{2} \qquad ( Equation 39 )$$

the height z₁ from the origin to the first inner hoop of the curved mirror surface is determined as the following Equation 40,
z₁=r(θ₁)cos θ₁ (Equation 40)

the height from the origin to the planar mirror surface is equal to the smaller one between zₒ⁽¹⁾ given in the following Equation 41 and zₒ⁽²⁾ given in the following Equation 42 (zₒ=min(zₒ⁽¹⁾, zₒ⁽²⁾),

$$\begin{matrix}{z}_{o}^{( 1 )} = \frac{{ρ}_{1} + {z}_{1} tan {θ}_{2}}{2 tan {θ}_{2}} \\ and & ( Equation 41 ) \\ {z}_{o}^{( 2 )} = \frac{{ρ}_{1} - {z}_{1} cot ( ψ + {μ}_{1} )}{ tan {θ}_{2} - cot ( ψ + {μ}_{1} )} & ( Equation 42 )\end{matrix}$$

the radius of the second inner hoop is set as no larger than ρ_{I} given in the following Equation 43,
ρ_{I}=zₒ tan θ₁ (Equation 43)

the radius of the second outer hoop is set as no smaller than ρ_{O} given in the following Equation 44,
ρ_{O}=zₒ tan θ₂ (Equation 44)

and the height from the origin of the spherical coordinate to the nodal point of the image capturing means is given as 2zₒ.

In accordance with another aspect of the present invention, there is provided a catadioptric complex imaging system, comprising: a first mirror surface and a second mirror surface respectively having a rotationally symmetric profile about a rotational symmetry axis; and an image capturing means having an optical axis and a nodal point, wherein the image capturing means and the mirror surfaces are arranged so that the first and second mirror surfaces are within the view of the image capturing means, wherein the profile of the first mirror surface is described with a set of coordinate pairs (θ_{I}, r_{I}(θ_{I})) in a spherical coordinate having the rotational symmetry axis as the z-axis, θ_{I} is the zenith angle of a first reflected ray reflected at a first point on the first mirror surface and passing through the origin of the spherical coordinate, the zenith angle θ_{I} ranges from zero to a maximum zenith angle θ_{I2} less than π/2(0≦θ_{I}≦θ_{I2}<π/2), and r_{I}(θ_{I}) is the corresponding distance from the origin of the spherical coordinate to the first point on the first mirror surface and satisfies the following Equation 45,

$${r}_{I} ( {θ}_{I} ) = {r}_{I} ( 0 ) exp [ {\int }_{0}^{{θ}_{I}} \frac{sin {θ}^{′} + cot {ϕ}_{I} ( {θ}^{′} ) cos {θ}^{′}}{cos {θ}^{′} - cot {ϕ}_{I} ( {θ}^{′} ) sin {θ}^{′}} ⅆ {θ}^{′} ] \qquad ( Equation 45 )$$

where r_{I}(0) is the corresponding distance from the origin to the intersection between the first mirror surface and the z-axis, the first reflected ray is formed by a first incident ray having a nadir angle δ_{I} ranging from zero to a maximum nadir angle δ_{I2} less than π/2(0≦δ_{I}≦δ_{I2}<π/2), the nadir angle δ_{I} is a function of the zenith angle θ_{I} having a maximum zenith angle θ_{I2} less than the maximum nadir angle δ_{I2}(0<θ_{I2}<θ_{I2}<π/2) and satisfies the following Equation 46,

$${δ}_{I} ( {θ}_{I} ) = {tan}^{- 1} ( \frac{tan {δ}_{I 2}}{tan {θ}_{I 2}} tan {θ}_{I} ) \qquad ( Equation 46 )$$

φ_{I}(θ_{I}) is the angle subtended by the z-axis and the first tangent plane to the first mirror surface at the first point, and is a function of θ_{I} and δ_{I} as the following Equation 47,

$${ϕ}_{I} ( {θ}_{I} ) = \frac{{θ}_{I} + ( π \pm {δ}_{I} )}{2} \qquad ( Equation 47 )$$

the profile of the second mirror surface is described with a set of coordinate pairs (θ_{O}, r_{O}(θ_{O})) in the spherical coordinate, θ_{O} is the zenith angle of a second reflected ray reflected at a second point on the second mirror surface and passing through the origin of the spherical coordinate, the zenith angle θ_{O} ranges from a minimum zenith angle θ_{O1} no less than θ_{I2} to a maximum zenith angle θ_{O2} less than π/2(θ_{I2}≦θ_{O1}≦θ_{O}≦θ^{O2}<π/2), and r_{O}(θ_{O}) is the corresponding distance from the origin of the spherical coordinate to the second point on the second mirror surface and satisfies the following Equation 48,

$${r}_{o} ( {θ}_{o} ) = {r}_{o} ( {θ}_{oi} ) exp [ {\int }_{{θ}_{oi}}^{{θ}_{o}} \frac{sin {θ}^{′} + cot {ϕ}_{o} ( {θ}^{′} ) cos {θ}^{′}}{cos {θ}^{′} - cot {ϕ}_{o} ( {θ}^{′} ) sin {θ}^{′}} ⅆ {θ}^{′} ] \qquad ( Equation 48 )$$

where θ_{Oi} is the zenith angle of a third reflected ray reflected at a third point on the second mirror surface and passing through the origin of the spherical coordinate, and r_{O}(θ_{Oi}) is the corresponding distance from the origin to the third point, a normal drawn from the second point to a cone compassing both the first and the second mirror surfaces and having the rotational symmetry axis coinciding with the z-axis has an altitude angle ψ, the altitude angle ψ is measured from the plane perpendicular to the z-axis (i.e., the x-y plane) toward the zenith, the second reflected ray is formed by a second incident ray having an elevation angle μₒ, the elevation angle μₒ is measured from the normal to the incident ray in the same direction as the altitude angle ψ and ranges from a minimum elevation angle μ_{O1} larger than −π/2 to a maximum elevation angle μ_{O2} less than π/2(−π/2<μ_{O1}≦μ_{O}≦μ_{O2}<π/2), and the elevation angle μ_{O} is a function of the zenith angle θ_{O} as the following Equation 49,

$${μ}_{O} ( {θ}_{O} ) = {tan}^{- 1} [ \frac{tan {μ}_{O 2} - tan {μ}_{O 1}}{tan {θ}_{O 2} - {tan}_{O 1}} ( tan {θ}_{O} - tan {θ}_{O 1} ) + tan {μ}_{1 \; 2} ] \qquad ( Equation 49 )$$

and φ_{O}(θ_{O}) is the angle subtended by the z-axis and the second tangent plane to the second mirror surface at the second point, and is a function of the zenith angle θ_{O} and the elevation angle μ_{O}(θ_{O}) as the following Equation 50,

$${ϕ}_{O} ( {θ}_{O} ) = \frac{{θ}_{O} + \frac{π}{2} - ψ - {μ}_{O} ( {θ}_{O} )}{2} \qquad ( Equation 50 )$$

the optical axis of the image capturing means coincides with the z-axis, and the nodal point of the image capturing means is located at the origin of the spherical coordinate.

In accordance with another aspect of the present invention, there is provided an imaging system for monitoring the surroundings of a moving object, comprising: a mirror including a mirror surface having a rotationally symmetric profile about the z-axis in a spherical coordinate, where the z-axis has zero zenith angle, and an image capturing means for monitoring the surroundings of a moving object, wherein the image capturing means having an optical axis and a nodal point, and the image capturing means and the mirror surface are arranged so that the mirror surface is within the view of the image capturing means, and a display means for displaying images captured by the image capturing means to a driver, wherein the profile of the mirror surface is described with a set of coordinate pairs (θ, r(θ)) in the spherical coordinate, θ is the zenith angle of a reflected ray reflected at a first point on the mirror surface and passing through the origin of the spherical coordinate, the zenith angle θ ranges from zero to a maximum zenith angle θ₂ less than π/2 (0≦θ≦θ₂<π/2), and r(θ) is the corresponding distance from the origin of the spherical coordinate to the first point on the mirror surface and satisfies the following Equation 51,

$$r ( θ ) = r ( 0 ) exp [ {\int }_{0}^{θ} \frac{sin {θ}^{′} + cot {ϕ}_{o} ( {θ}^{′} ) cos {θ}^{′}}{cos {θ}^{′} - cot {ϕ}_{o} ( {θ}^{′} ) sin {θ}^{′}} ⅆ {θ}^{′} ] \qquad ( Equation 51 )$$

where r(0) is the distance from the origin to the intersection between the mirror surface and the z-axis, the first reflected ray is formed by an incident ray having a nadir angle δ ranging from zero to a maximum nadir angle δ₂ less than π/2 (0≦δ≦δ₂<π/2), the nadir angle δ is a function of the zenith angle θ and satisfies the following Equation 52,

$$δ ( θ ) = {tan}^{- 1} ( \frac{tan {δ}_{2}}{tan {θ}_{2}} tan θ ) \qquad ( Equation 52 )$$

φ(θ) is the angle subtended by the z-axis and the tangent plane to the mirror surface at the first point, and is a function of θ and δ(θ) as the following Equation 53,

$$ϕ ( θ ) = \frac{θ + π \pm δ ( θ )}{2} \qquad ( Equation 53 )$$

the optical axis of the image capturing means coincides with the z-axis, and the nodal point of the image capturing means is located at the origin of the spherical coordinate.

In accordance with another aspect of the present invention, there is provided an imaging system for monitoring the surroundings of a moving object, comprising: a mirror including a mirror surface having a rotationally symmetric profile about the z-axis in a spherical coordinate, where the z-axis has zero zenith angle, and an image capturing means for monitoring the surroundings of a moving object, wherein the image capturing means having an optical axis and a nodal point, and the image capturing means and the mirror surface are arranged so that the mirror surface is within the view of the image capturing means, and a display means for displaying images captured by the image capturing means to a driver, wherein the profile of the mirror surface is described with a set of coordinate pairs (θ, r(θ)) in the spherical coordinate, θ is the zenith angle of a first reflected ray reflected at a first point on the mirror surface and passing through the origin of the spherical coordinate, the zenith angle θ ranges from a minimum zenith angle θ₁ larger than zero to a maximum zenith angle θ₂ less than π/2 (0<θ₁≦θ≦θ₂<π/2), and r(θ) is the corresponding distance from the origin of the spherical coordinate to the first point on the mirror surface and satisfies the following Equation 54,

$$r ( θ ) = r ( {θ}_{i} ) exp [ {\int }_{{θ}_{i}}^{{θ}_{o}} \frac{sin {θ}^{′} + cot {ϕ}_{o} ( {θ}^{′} ) cos {θ}^{′}}{cos {θ}^{′} - cot {ϕ}_{o} ( {θ}^{′} ) sin {θ}^{′}} ⅆ {θ}^{′} ] \qquad ( Equation 54 )$$

where θᵢ is the zenith angle of a second reflected ray reflected at a second point on the mirror surface and passing through the origin of the spherical coordinate, and r(θᵢ) is the corresponding distance from the origin to the second point, a normal drawn from the first point to a cone compassing the mirror surface and having the rotational symmetry axis coinciding with the z-axis has an altitude angle ψ, where the altitude angle ψ is measured from the plane perpendicular to the z-axis (i.e., the x-y plane) toward the zenith, the first reflected ray is formed by an incident ray having an elevation angle μ, the elevation angle μ is measured from the normal to the incident ray in the same direction as the altitude angle ψ, the altitude angle ψis bounded between −π/2 and π/2(−π/2<ψ<π/2), the elevation angle μ ranges from μ₁ larger than −π/2 to λ₂ less than π/2 (−π/2<μ₁≦μ≦μ₂<π/2), and the elevation angle μ is a function of the zenith angle θ as the following Equation 55,

$$μ ( θ ) = {tan}^{- 1} [ \frac{tan {μ}_{2} - tan {μ}_{1}}{tan {θ}_{2} - {tan}_{1}} ( tan θ - tan {θ}_{1} ) + tan {μ}_{1} ] \qquad ( Equation 55 )$$

φ(θ) is the angle subtended by the z-axis and the tangent plane to the mirror surface at the first point, and is a function of the zenith angle θ and the elevation angle μ(θ) as the following Equation 56,

$$ϕ ( θ ) = \frac{θ + \frac{π}{2} - ψ - μ ( θ )}{2} \qquad ( Equation 56 )$$

the optical axis of the image capturing means coincides with the z-axis, and the nodal point of the image capturing means is located at the origin of the spherical coordinate.

In accordance with another aspect of the present invention, there is provided an imaging system for monitoring the surroundings of a moving object, comprising: a first mirror including a curved mirror surface having a rotationally symmetric profile about a rotational symmetry axis, wherein the curved mirror surface extends from a first inner hoop having a radius ρ₁ to a first outer hoop having a radius ρ₂, and the first mirror has a circular hole inside of the inner hoop; a second mirror including a planar mirror surface facing the curved mirror surface, wherein the planar mirror has a ring shape defined with a second inner hoop having a radius ρ_{I} and a second outer hoop having a radius ρ_{O}; and an image capturing means for monitoring the surroundings of the moving object, wherein the image capturing means having an optical axis and a nodal point, and the image capturing means and the mirror surfaces are arranged so that the planar mirror surface is within the view of the image capturing means, and a display means for displaying images captured by the image capturing means to a driver, wherein all the radii of the first inner hoop, the second inner hoop, the first outer hoop and the second outer hoop are measured in a direction normal to the rotational symmetry axis, the first mirror and the second mirror share the same rotational symmetry axis coinciding with the optical axis of the image capturing means, the curved mirror surface is described with a set of coordinate pairs (θ, r(θ)) in a spherical coordinate having the rotational symmetry axis as the z-axis, wherein θ is the zenith angle of a first reflected ray reflected at a first point on the curved mirror surface and passing through the origin of the spherical coordinate, the zenith angle of the z-axis is zero, the zenith angle θ ranges from a minimum zenith angle θ₁ larger than zero to a maximum zenith angle θ₂ less than π/2(0<θ₁≦θ≦θ₂<π/2), and r(θ) is the corresponding distance from the origin of the spherical coordinate to the first point on the curved mirror surface and satisfies the following Equation 57,

$$r ( θ ) = r ( {θ}_{i} ) exp [ {\int }_{{θ}_{i}}^{θ} \frac{sin {θ}^{′} + cot ϕ ( {θ}^{′} ) cos {θ}^{′}}{cos {θ}^{′} - cot ϕ ( {θ}^{′} ) sin {θ}^{′}} ⅆ {θ}^{′} ] \qquad ( Equation 57 )$$

where θᵢ is the zenith angle of a second reflected ray reflected at a second point of the curved mirror surface and passing through the origin of the spherical coordinate, and r(θᵢ) is the corresponding distance from the origin to the second point, the radius ρ_{I} of the first inner hoop is determined as Equation 58,
ρ₁=(θ₁)sin θ₁ (Equation 58)

the radius ρ₂ of the first outer hoop is determined as Equation 59,
ρ₂=r(θ₂)sin θ₂ (Equation 59)

a normal drawn from the first point to a cone compassing both the curved mirror and the planar mirror and having the rotational symmetry axis coinciding with the z-axis has an altitude angle ψ, the altitude angle ψ is measured from the plane perpendicular to the z-axis (i.e., the x-y plane) toward the zenith, the first reflected ray is formed by a first incident ray having an elevation angle μ, where the elevation angle μ is the angle measured from the normal to the incident ray in the same direction as the altitude angle ψ, the altitude angle ψ is bounded between −π/2 and π/2(−π/2<ψ<π/2), the elevation angle μ ranges from a minimum elevation angle μ₁ larger than −/2 to a maximum elevation angle μ₂ less than π/2(−π/2<μ₁≦μ≦μ₂<π/2), and the elevation angle μ is a function of the zenith angle θ as the following Equation 60,

$$μ ( θ ) = {tan}^{- 1} [ \frac{tan {μ}_{2} - tan {μ}_{1}}{tan {θ}_{2} - tan {θ}_{1}} ( tan θ - tan {θ}_{1} ) + tan {μ}_{1} ] \qquad ( Equation 60 )$$

and φ(θ) is the angle subtended by the z-axis and the tangent plane to the curved mirror surface at the first point, and is a function of the zenith angle θ and the elevation angle μ(θ) as the following Equation 61,

$$ϕ ( θ ) = \frac{θ + \frac{π}{2} - ψ - μ ( θ )}{2} \qquad ( Equation 61 )$$

the height z₁ from the origin to the first inner hoop of the curved mirror surface is determined as the following Equation 62,
z₁=r(θ₁)cos θ₁ (Equation 62)

the height from the origin to the planar mirror surface is equal to the smaller one between zₒ⁽¹⁾ given as the following Equation 63 and zₒ⁽²⁾ given as the following Equation 64 (zₒ=min(zₒ⁽¹⁾, zₒ⁽²⁾)

$$\begin{matrix}{z}_{o}^{( 1 )} = \frac{{ρ}_{1} + {z}_{1} tan {θ}_{2}}{2 tan {θ}_{2}} \\ and & ( Equation 63 ) \\ {z}_{o}^{( 2 )} = \frac{{ρ}_{1} - {z}_{1} cot ( ψ + {μ}_{1} )}{ tan {θ}_{2} - cot ( ψ + {μ}_{1} )} & ( Equation 64 )\end{matrix}$$

the radius of the second inner hoop is set as no larger than ρ_{I} given in the following Equation 65,
ρ_{I}=zₒ tan θ₁ (Equation 65)

the radius of the second outer hoop is set as no smaller than ρₒ given in the following Equation 66:
ρ_{O}zₒ tan θ₂ (Equation 66)

and the height from the origin of the spherical coordinate to the nodal point of the image capturing means is given as 2zₒ.

In accordance with another aspect of the present invention, there is provided an imaging system for monitoring the surroundings of a moving object, comprising: a first mirror surface and a second mirror surface respectively having a rotationally symmetric profile about a rotational symmetry axis; and an image capturing means for monitoring the surroundings of a moving object, wherein the image capturing means having an optical axis and a nodal point, and the image capturing means and the first and the second mirror surfaces are arranged so that the first and the second mirror surfaces are within the view of the image capturing means, and a display means for displaying images captured by the image capturing means to a driver, wherein the profile of the first mirror surface is described with a set of coordinate pairs (θ_{I}, r_{I}(θ_{I})) in a spherical coordinate having the rotational symmetry axis as the z-axis, θ_{I} is the zenith angle of a first reflected ray reflected at a first point on the first mirror surface and passing through the origin of the spherical coordinate, the zenith angle θ_{I} ranges from zero to a maximum zenith angle θ_{I2} less than π/2 (0≦θ_{I}≦θ_{I2}<π/2), and r_{I}(θ_{I}) is the corresponding distance from the origin of the spherical coordinate to the first point on the first mirror surface and satisfies the following Equation 67:

$${r}_{I} ( {θ}_{I} ) = {r}_{I} ( 0 ) exp [ {\int }_{0}^{{θ}_{I}} \frac{sin {θ}^{′} + cot {ϕ}_{I} ( {θ}^{′} ) cos {θ}^{′}}{cos {θ}^{′} - cot {ϕ}_{I} ( {θ}^{′} ) sin {θ}^{′}} ⅆ {θ}^{′} ] \qquad ( Equation 67 )$$

where r_{I}(0) is the distance from the origin to the intersection between the first mirror surface and the z-axis, the first reflected ray is formed by a first incident ray having a nadir angle δ_{I} ranging from zero to a maximum nadir angle δ_{I2} less than π/2(0≦δ_{I}≦δ_{I2}<π/2), the nadir angle δ_{I} is a function of the zenith angle θ_{I} having a maximum zenith angle θ_{I2} less than the maximum nadir angle δ_{I2}(0<θ_{I2}<δ_{I2}<π/2), and satisfies the following Equation 68,

$${δ}_{I} ( {θ}_{I} ) = {tan}^{- 1} ( \frac{tan {δ}_{I 2}}{tan {θ}_{I 2}} tan {θ}_{I} ) \qquad ( Equation 68 )$$

φ_{I}(θ_{I}) is the angle subtended by the z-axis and the first tangent plane to the first mirror surface at the first point, and is a function of θ_{I} and δ_{I} as the following Equation 69,

$${ϕ}_{I} ( {θ}_{I} ) = \frac{{θ}_{I} + ( π \pm {δ}_{I} )}{2} \qquad ( Equation 69 )$$

the profile of the second mirror surface is described with a set of coordinate pairs (θ_{O}, r_{O}(θ_{O})) in the spherical coordinate, θ_{O} is the zenith angle of a second reflected ray reflected at a second point on the second mirror surface and passing through the origin of the spherical coordinate, the zenith angle θ_{O} ranges from a minimum zenith angle θ_{O1} no less than θ_{I2} to a maximum zenith angle θ_{O2} less than π/2 (θ_{I2}≦θ_{O1}≦θ_{O}≦θ_{O2}<π/2), and r_{O}(θ_{O}) is the corresponding distance from the origin of the spherical coordinate to the second point on the second mirror surface and satisfies the following Equation 70,

$${r}_{o} ( {θ}_{o} ) = {r}_{o} ( {θ}_{oi} ) exp [ {\int }_{{θ}_{oi}}^{{θ}_{o}} \frac{sin {θ}^{′} + cot {ϕ}_{o} ( {θ}^{′} ) cos {θ}^{′}}{cos {θ}^{′} - cot {ϕ}_{o} ( {θ}^{′} ) sin {θ}^{′}} ⅆ {θ}^{′} ] \qquad ( Equation 70 )$$

where θ_{Oi} is the zenith angle of a third reflected ray reflected at a third point on the second mirror surface and passing through the origin of the spherical coordinate, and r_{O}(θ_{Oi}) is the corresponding distance from the origin to the third point, a normal drawn from the second point to a cone compassing both the first and the second mirror surfaces and having the rotational symmetry axis coinciding with the z-axis has an altitude angle ψ,

the altitude angle ψ is measured from the plane perpendicular to the z-axis (i.e., the x-y plane) toward the zenith, the second reflected ray is formed by a second incident ray having an elevation angle μₒ, the elevation angle μₒ is measured from the normal to the incident ray in the same direction as the altitude angle ψ and ranges from a minimum elevation angle μ_{O1} larger than −π/2 to a maximum elevation angle μ_{O2} less than π/2 (−π/2<μ_{O1}≦μ_{O}≦μ_{O2}<π/2), and the elevation angle μ_{O} is a function of the zenith angle θ_{O} as the following Equation 71,

$${μ}_{O} ( {θ}_{O} ) = {tan}^{- 1} [ \frac{tan {μ}_{O 2} - tan {μ}_{O 1}}{tan {θ}_{O 2} - {tan}_{O 1}} ( tan {θ}_{O} - tan {θ}_{O 1} ) + tan {μ}_{O1} ] \qquad ( Equation 71 )$$

φ_{O}(θ_{O}) is the angle subtended by the z-axis and the second tangent plane to the second mirror surface at the second point, and is a function of the zenith angle θ_{O} and the elevation angle μ_{O}(θ_{O}) as the following Equation 72,

$${ϕ}_{O} ( {θ}_{O} ) = \frac{{θ}_{O} + \frac{π}{2} - ψ - {μ}_{O} ( {θ}_{O} )}{2} \qquad ( Equation 72 )$$

the optical axis of the image capturing means coincides with the z-axis, and the nodal point of the image capturing means is located at the origin of the spherical coordinate.

### BRIEF DESCRIPTION OF THE DRAWINGS

FIG. 1 is a schematic diagram illustrating a wide-angle imaging system having a convex mirror in accordance with a prior art.

FIG. 2 is a schematic diagram illustrating a stereovision system in accordance with another prior art.

FIGS. 3 through 7 are schematic diagrams illustrating the structure of panoramic stereovision systems in accordance with prior arts.

FIG. 8 is a schematic diagram illustrating an imaging system including a convex rectilinear wide-angle mirror and an image sensor in accordance with the first embodiment of the present invention.

FIGS. 9 and 10 are schematic diagrams illustrating the relations among the size of an image sensor, the focal length of a lens and the field of view (FOV).

FIG. 11 shows the surface profile of a convex rectilinear wide-angle mirror in accordance with the first embodiment of the present invention.

FIG. 12 shows the surface profile of the convex rectilinear wide-angle mirror shown in FIG. 11 fitted a 10^{th} order power series in ρ.

FIG. 13 shows the relation between the real object distances and the corresponding image distances on the image sensor in an imaging system in accordance with the first embodiment of the present invention.

FIG. 14 is a schematic diagram illustrating an imaging system including a concave rectilinear wide-angle mirror and an image sensor in accordance with the second embodiment of the present invention.

FIG. 15 shows the surface profile of a concave rectilinear wide-angle mirror in accordance with the second embodiment of the present invention.

FIG. 16 shows the surface profile of the concave rectilinear wide-angle mirror shown in FIG. 15 fitted an 8^{th} order power series in ρ.

FIG. 17 shows the relation between the real object distances and the corresponding image distances on the image sensor in an imaging system in accordance with the second embodiment of the present invention.

FIG. 18 is a schematic diagram illustrating the projection scheme and the field of view (FOV) of rectilinear panoramic imaging system in accordance with the third embodiment of the present invention.

FIG. 19 is a schematic diagram illustrating a rectilinear panoramic imaging system in accordance with the third embodiment of the present invention.

FIG. 20 shows the relation between the zenith angle of the reflected ray and the elevation angle of the incident ray in a rectilinear panoramic imaging system of the present invention.

FIGS. 21 through 23 show surface profiles of normal-type and inverting-type rectilinear panoramic mirrors in accordance with embodiments of the present invention.

FIGS. 24 and 25 are schematic diagrams illustrating complex mirrors and imaging systems having the same in accordance with the fourth and the fifth embodiments of the present invention.

FIG. 26 is a schematic diagram illustrating a stereovision system including a rectilinear double panoramic mirror in accordance with the sixth embodiment of the present invention.

FIG. 27 is a schematic diagram illustrating the principle of distance measurement in a stereovision system.

FIG. 28 is a schematic diagram illustrating a stereovision system employing another double rectilinear panoramic mirror in accordance with the seventh embodiment of the present invention.

FIG. 29 is a diagram illustrating a folded rectilinear panoramic imaging system employing two mirrors in accordance with the eighth embodiment of the present invention.

FIG. 30 is a perspective view of the panoramic mirror shown in FIG. 29.

FIGS. 31 through 34 are diagrams illustrating the locations and the sizes of planar mirrors in folded rectilinear panoramic imaging systems.

FIGS. 35 through 40 are schematic diagrams illustrating various imaging systems in accordance with the embodiments of the present invention.

FIGS. 41 and 42 show appliances of the imaging system of the present invention.

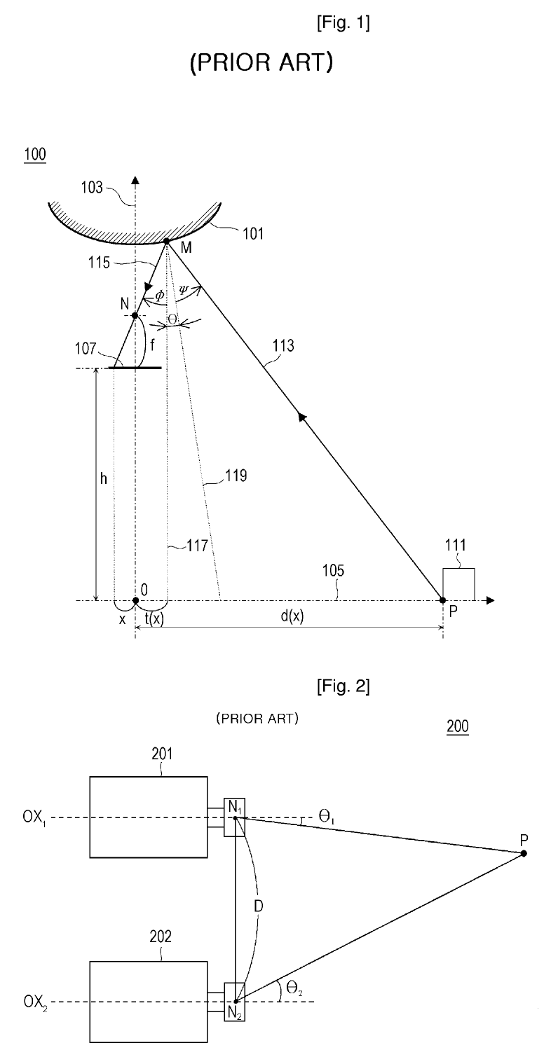

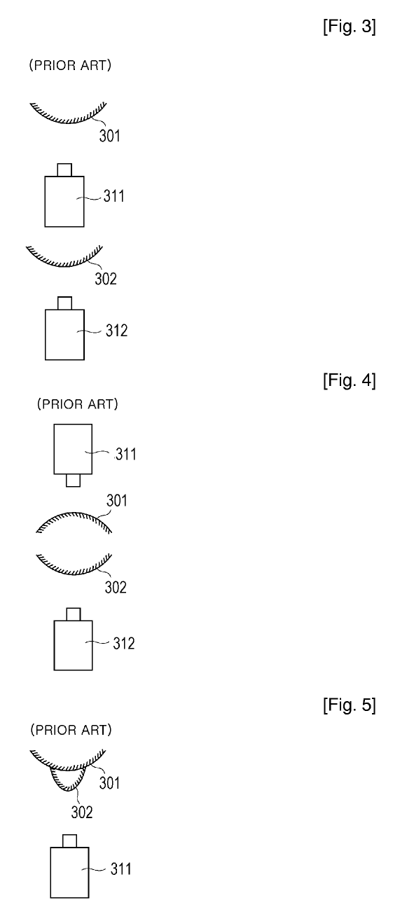

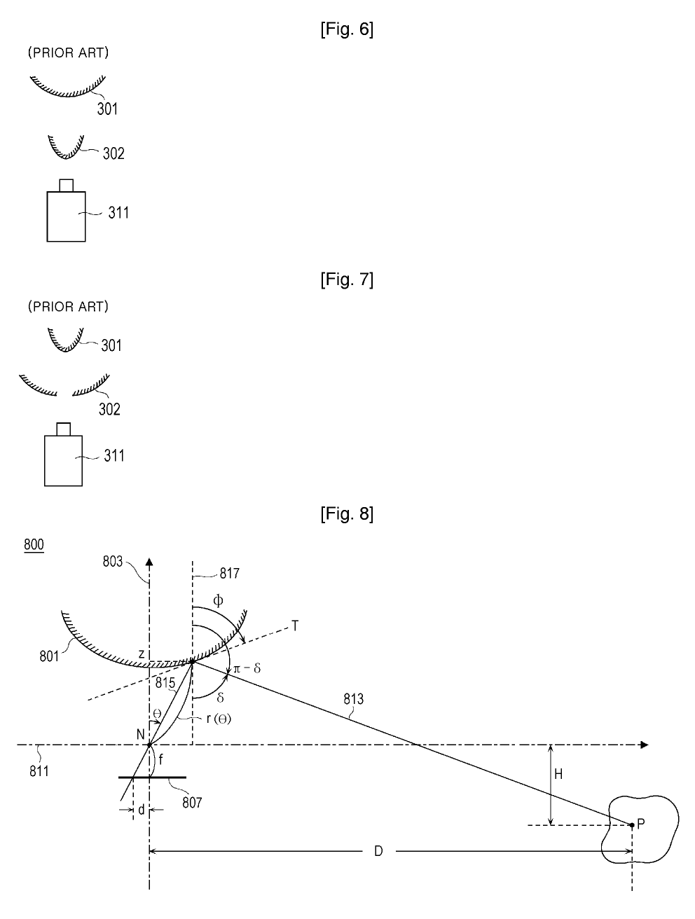

### BEST MODE FOR CARRYING OUT THE INVENTION

Referring to FIG. 8 through 42, the preferable embodiments of the present invention will be described.

### First Embodiment

FIG. 8 is a schematic diagram illustrating an imaging system including a convex rectilinear wide-angle mirror and an image sensor in accordance with the first embodiment of the present invention.

As shown in FIG. 8, a wide-angle mirror surface 801 in accordance with the first embodiment of the present invention has a rotationally symmetric profile. A rotational symmetry axis 803 and the optical axis of the camera in the imaging system are identical to the z-axis of the coordinates system. A nodal point N of the camera coincides with the reference position on the symmetry axis (i.e., the origin of the coordinates). An incident ray 813 has a nadir angle d, and therefore the zenith angle of the incident ray 813 is π-δ. A nadir angle is an angle measured from the negative z-axis toward the zenith, while a zenith angle is an angle measured from the positive z-axis toward the nadir. According to the definitions, the sum of the zenith angle and the nadir angle equals π. The incident ray 813 is reflected at a point M on the wide-angle mirror surface 801, and the reflected ray reflected at the point M passes through the nodal point N with a zenith angle θ.

The location of the point M can be defined with two variables (ρ, z) in a cylindrical coordinate, namely, an axial radius ρ (i.e., a perpendicular distance from the rotational symmetry axis 803), and a height z measured parallel to the rotational symmetry axis 803. More conveniently, the surface profile of the panoramic mirror 801 can be defined by providing a function z=z(ρ). Therefore, the radius ρ becomes an independent variable and the height z becomes a dependent variable.

The location of the point M can, also, be expressed in a spherical coordinate with the zenith angle θ of the reflected ray 815 and the radial distance r from the nodal point (origin) N to the mirror point M. As in the cylindrical coordinate, the surface profile of the wide-angle mirror 801 can be given in terms of the dependent variable r as a function of the independent variable θ as given in Equation 11.
r=r(θ) MathFigure 11

The two variables (ρ, z) in the cylindrical coordinate can be given in terms of the independent variable θ in the spherical coordinate as given in the Equations 12 and 13.
z(θ)=r(θ)cos θ MathFigure 12
ρ(θ)=r(θ)sin θ MathFigure 13

The profile of the mirror surface can also be defined by assigning a zenith angle φ(φ=φ(θ)) of the tangent plane T at an arbitrary point M(θ, r(θ)) on the mirror surface.

The profile of the mirror surface is designed so that an incident ray 813 propagating toward the mirror surface from all directions (i.e., with an arbitrary azimuth angle) having a nadir angle δ between zero and δ₂(δ₂<π/2) is reflected on the mirror surface and the resulting reflected ray 815 having a zenith angle θ between zero and θ₂ passes through the nodal point N of the camera and is captured by the image sensor 807. Then, the zenith angle φ of the tangent plane T satisfies the following Equation 14.

$$tan ϕ = \frac{ⅆ ρ}{ⅆ z} \qquad MathFigure 14$$

Both z and ρ can be given as functions of θ using the Equations 12 and 13. The following Equation 15 can be obtained by inverting the Equation 14. It is required to invert the Equation 14 because tan φ diverges to infinity near φ=90°.

$$cot ϕ = \frac{ⅆ z}{ⅆ ρ} = \frac{ⅆ θ}{ⅆ ρ} \frac{ⅆ z}{ⅆ θ} = \frac{\frac{ⅆ z}{ⅆ θ}}{\frac{ⅆ ρ}{ⅆ θ}} \qquad MathFigure 15$$

In order to calculate the numerator in the Equation 15, namely, dz/dθ, Equation 16 is obtained by differentiating the Equation 12.

$$\frac{ⅆ z}{ⅆ θ} = \frac{ⅆ r}{ⅆ θ} cos θ - r sin θ = {r}^{′} cos θ - r sin θ \qquad MathFigure 16$$

In the same manner, in order to calculate the denominator in the Equation 15, namely, dρ/dθ, Equation 17 is obtained by differentiating the Equation 13.

$$\frac{ⅆ ρ}{ⅆ θ} = {r}^{′} sin θ + r cos θ \qquad MathFigure 17$$

The Equation 15 is then reduced to the Equation 18 using the Equations 16 and 17.

$$cot ϕ = \frac{{r}^{′} cos θ - r sin θ}{{r}^{′} sin θ + r cos θ} \qquad MathFigure 18$$

As schematically shown in FIG. 8, reflections at the mirror surface 801 follow the familiar law of specular reflection. Therefore, the zenith angle φ of the tangent plane T can be given as a function of the nadir angle δ of the incident ray 813 and the zenith angle θ of the reflected ray 815 as the following Equation 19.

$$ϕ = \frac{θ + ( π - δ )}{2} \qquad MathFigure 19$$

After a separation of variables, the Equation 18 can be reduced to the Equation 20.

$$\frac{{r}^{′}}{r} = \frac{sin θ + cot ϕ cos θ}{cos θ - cot ϕ sin θ} \qquad MathFigure 20$$

By formally integrating the Equation 20, the following Equation 21 can be obtained.

$$r ( θ ) = r ( 0 ) exp [ {\int }_{0}^{θ} \frac{sin {θ}^{′} + cot ϕ ( {θ}^{′} ) cos {θ}^{′}}{cos {θ}^{′} - cot ϕ ( {θ}^{′} ) sin {θ}^{′}} ⅆ {θ}^{′} ] \qquad MathFigure 21$$

In the Equation 21, θ′ is a dummy variable, the lower bound of the indefinite integral is zero (θ=0), and r(0) is the distance from the coordinate origin to the intersection between the mirror surface 801 and the rotational symmetry axis 803. As mentioned above, the nodal point N of the camera is located at the origin. The variables θ₂, δ₂, and φ(θ) are design parameters for designing the profile of the wide-angle mirror surface 801 of the present invention. Particularly, θ₂ is the FOV of a refractive lens employed with the wide-angle mirror, and δ₂ is the FOV of the catadioptric wide-angle imaging system as a whole. The boundary values of the function φ(θ) are determined as φ₁=π/2 and φ₂=(θ₂+π−δ₂)/2 in accordance with the Equation 19. Between zero and θ₂, the profile of the mirror surface is designed as to follow a rectilinear projection scheme in order to minimize the barrel distortion.

As mentioned previously, the rectilinear mirror of the prior art satisfies the Equation 10 at a predetermined height h from the ground. The wide-angle imaging system cannot satisfy the Equation 10 at other heights, because the wide-angle imaging system of the prior art is not a single viewpoint imaging system. Namely, in the wide-angle imaging system, the incident rays corresponding to the reflected rays passing through the nodal point do not converge to a single point even when they continue propagating in their original directions without being reflected on the mirror. Generally, an imaging system employing only one mirror cannot simultaneously satisfy the Equation 10 (or other projection scheme) and have a single viewpoint. Therefore, a rectilinear wide-angle imaging system employing a single mirror is obtained by approximately embodying an ideal single viewpoint rectilinear projection scheme. In this regards, various rectilinear projection schemes can be used in realizing wide-angle imaging systems. This can be compared to a matter of choice between a more comfortable car with a less fuel-efficient engine and a less comfortable car with an excellent fuel-efficient engine assuming that a car perfect in every aspect is not possible. In other words, if a perfect solution is fundamentally impossible, then there can be many approximate solutions in various forms.

In the rectilinear projection scheme of the current invention, the ratio of tangent of the nadir angle δ of the incident ray 813 and the tangent of the zenith angle θ of the reflected ray 815 is maintained as a constant as in the following Equation 22.
tan δ=C tan θ MathFigure 22

In the Equation 22, C is a constant. In the present invention, it is not assumed that the mirror surface 801 is located at a predetermined height from the ground or from an object. Instead, if the ratio of the tangent of the nadir angle of the incident ray and the tangent of the zenith angle of the reflected ray is maintained as a constant, then an object with an arbitrary height is captured in a uniformly reduced manner. Consequently, it can be seen that the projection scheme given by the Equation 22 is superior to those given by the Equation 10.

Since the maximum nadir angle of the incident ray 813 is δ₂ and the corresponding maximum zenith angle of the reflected ray 815 is θ₂, the constant C can be determined uniquely. Therefore, the nadir angle δ of an incident ray is given as the following Equation 23.

$$δ = {tan}^{- 1} ( \frac{tan {δ}_{2}}{tan {θ}_{2}} tan θ ) \qquad MathFigure 23$$

To obtain a sharp image, the distance between the nodal point N and the image sensor 807 should be nearly equal to the focal length f of the camera lens. Therefore, the radius d from the center of the image sensor 807, namely, the intersection of the image sensor 807 and the optical axis 803, to the pixel by which the reflected ray 815 is captured is given as the following Equation 24.
d=f tan θ MathFigure 24

Meanwhile, if the incident ray 813 has originated from a point P of an object with a height (or, depth) H below the nodal point N of the camera, then the horizontal distance (i.e., axial radius) D from the optical axis 803 to the object point P is given as the following Equation 25.
D=ρ+(z+H)tan δ MathFigure 25

Therefore, the projection scheme given in the Equation 23 results in the following Equation 26.

$$C = \frac{tan δ}{tan θ} = \frac{\frac{D - ρ}{H + z}}{\frac{d}{f}} = \frac{f}{d} \frac{D - ρ}{H + z} \approx \frac{f}{H} \frac{D}{d} \qquad MathFigure 26$$

If the values of ρ and z are small compared to those of D and H, then the axial radius d of the pixel on the image sensor becomes proportional to the actual distance D of the object point P from the optical axis (D∝d). Accordingly, in the imaging system of the present invention, when the mirror is smaller than the distance of the object from the optical axis, the image distortion due to the finite size of the mirror will be negligible.

The following explains the ranges of the nadir angle δ of the incident ray 813 and the zenith angle θ of the reflected ray 815 that must be considered in designing the surface profile of the wide-angle mirror 801.

By the mathematical nature of the rectilinear projection scheme, the maximum nadir angle δ₂ of the incident ray cannot exceed π/2 (i.e., 90°). More preferably, the maximum value of nadir angle δ should be less than 80°.

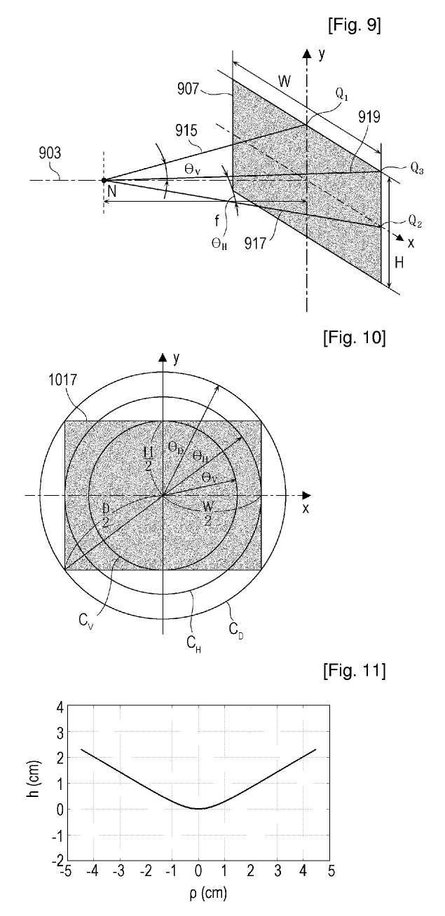

Meanwhile, the maximum zenith angle θ₂ of the reflected ray is determined by the focal length f of the camera lens and the size of the image sensor 807. As illustrated in FIG. 9, most of the image sensors, such as a charge-coupled device (CCD) sensor and a complementary metal oxide semiconductor (CMOS) sensor, have a rectangular shape having the ratio of the width to the height (W:H) as 4:3. Coordinates of a pixel on the image sensor can be expressed with a pair of x and y, e.g., (x, y).

For the image sensor 907 schematically shown in FIG. 9 where the width is W and the height is H, the range of x is −W/2≦x≦W/2 and the range of y is −H/2≦y≦H/2. Further, the distance between the nodal point N of the camera lens and the image sensor 907 equals the focal length f of the camera.

A reflected ray 915 arriving at a point Q₁ at x=0 and y=H/2 located on the upper horizontal edge of the image sensor 907, for instance, subtends an angle θ_{V} with the plane determined by the x-axis and the optical axis 903, namely the only plane that contains both the optical axis 903 and the x-axis. The angle θ_{V} is given as the following Equation 27.

$${θ}_{V} = {tan}^{- 1} ( \frac{H}{2 f} ) \qquad MathFigure 27$$

Similarly, a reflected ray 917 arriving at a point Q₂ at x=W/2 and y=0 located at the right vertical edge of the image sensor 907, for instance, subtends an angle θ_{H} with the plane determined by the y-axis and the optical axis 903. The angle θ_{H} is given as the following Equation 28.

$${θ}_{H} = {tan}^{- 1} ( \frac{W}{2 f} ) \qquad MathFigure 28$$

In the same manner, a reflected ray 919 arriving at a point Q₃ at x=W/2 and y=H/2 located at the upper right corner of the image sensor, for instance, subtends an angle θ_{D} with the optical axis. The angle θ_{D} is given as the following Equation 29.

$${θ}_{D} = {tan}^{- 1} ( \frac{\sqrt{{W}^{2} + {D}^{2}}}{2 f} ) \qquad MathFigure 29$$

To take an example, in an imaging system equipped with a ¼-inch CCD sensor having a width W of 3.2 mm, a height H of 2.4 mm, a diagonal D of 4.0 mm, and a 6 mm focal length lens, the angles θ_{V}, θ_{H} and θ_{D} become 11.31°, 14.93° and 18.43°, respectively (i.e., θ_{V}=11.31°, θ_{H}=14.93°, θ_{D}=18.43°).

FIG. 10 is a schematic diagram illustrating the relation between the range of the zenith angle θ of the reflected ray and the size of the image sensor 1017. In designing a wide-angle mirror, if the maximum zenith angle θ₂ of the reflected ray is identical to the angle θ_{V}, the reflected rays reflected on the wide-angle mirror are captured within a first circle C_{V} in the image sensor having a radius H/2, and images of the surroundings of the mirror will be captured outside region of the first circle C_{V}. Images obtained in this case are similar to those obtained with circular fisheye lenses. On the other hand, if the maximum zenith angle θ₂ of the reflected ray is identical to the angle θ_{D}, the reflected rays reflected on the wide-angle mirror are captured within a third circle C_{D} having a radius D/2, and only the images reflected by the wide-angle mirror are captured by the image sensor. Images obtained in this case are similar to those obtained by diagonal fisheye lenses, namely, full-frame fisheye lenses. Thus, the profile of the wide-angle mirror can be determined by adjusting the value of the maximum zenith angle θ₂ of the reflected ray depending on the type of images desired.

In the preferred embodiment of the present invention, the maximum zenith angle θ₂ of the reflected ray is set similar to the angle θ_{D} in order to obtain images similar to those of the diagonal fisheye lenses. When the maximum zenith angle θ₂ of the reflected ray is set identical to or greater than θ_{D} and the corresponding maximum nadir angle δ₂ of the incident ray is δ_{D}, the maximum nadir angle δ_{V} of the incident ray in the vertical direction (the y direction) is given as the following Equation 30.

$${δ}_{V} = {tan}^{- 1} ( \frac{tan {δ}_{D}}{tan {θ}_{D}} tan {θ}_{V} ) \qquad MathFigure 30$$

Under the aforementioned conditions, when the maximum zenith angle θ_{D} of the reflected ray is 20.0° (θ_{D}=20.0°) and the maximum nadir angle δ_{D} of the incident ray is 80.0° (δ_{D}=80.0°), the maximum nadir angles δ_{V} and δ_{H} of the incident rays in the vertical and the horizontal directions become 72.21° and 76.47°, respectively (δ_{V}=72.21°, δ_{H}=76.47°).

By using the equations 19, 21 and 23, the surface profile of the mirror can be obtained merely by calculating an indefinite integral. Only a basic technique of numerical analysis is required to calculate the indefinite integral given in the Equation 21, and thus the present invention can be easily used in industry.

In the prior art, the angular ranges of the incident and the reflected rays should be calculated from the structure of the imaging system. For the present invention, however, important characteristics of the imaging system such as the working distance of the refractive lens (i.e., the minimum distance between the refractive lens and the rectilinear mirror) and the angular ranges of the incident and the reflected rays are either readily available from the specifications of the refractive lens or directly corresponds to the goal the designer tries to accomplish. Therefore, designing a rectilinear mirror using the formula of the current invention is very easy and convenient.

FIG. 11 shows the surface profile of a convex rectilinear wide-angle mirror designed using the Equation 21. The profile of the convex rectilinear wide-angle shown in FIG. 11 is obtained under the assumptions that the maximum zenith angle θ₂ of the reflected ray is 20.0°, the maximum nadir angle δ₂ of the incident ray is 80.0°, and the distance from the nodal point N of the camera lens to the lowest point of the mirror (i.e., r=r(θ=0)=zₒ) is 10.0 cm. Plotted in FIG. 11 is the difference in mirror height obtained by subtracting the height of the lowest point on the mirror from the mirror height obtained using the Equation 21. That is, h(ρ)=z(ρ)−zₒ.

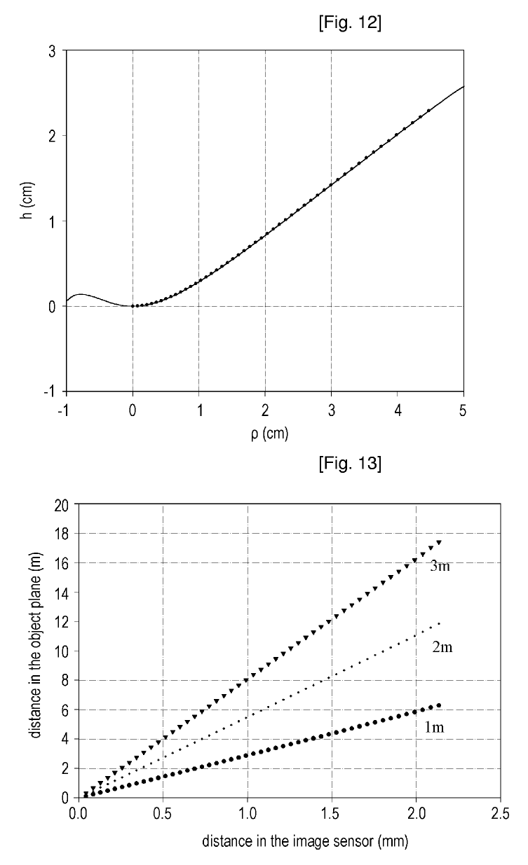

FIG. 12 shows the surface profile of the convex rectilinear wide-angle mirror in FIG. 11 fitted to a 10^{th} order power series in ρ. In FIG. 12, the dotted line shows the profile of mirror surface obtained using the Equation 21 and the solid line shows the fitted result fitted to a 10^{th} order power series in ρ using the least square error method. The minimum order to maintain the errors between the mirror surface profile obtained using the Equation 21 and the fitted result below 1 um is 10. The 10^{th} order power series is given as the following Equation 31.

$$h ( ρ ) = {\sum }_{n = 0}^{10} {C}_{n} {ρ}^{n} \qquad MathFigure 31$$

In Equation 31, Cₙ denotes a coefficient of the power series. The following table 1 shows these coefficients.

TABLE 1

| Coefficients | Value |
|---|---|
| min(ρ) = ρ₁ | 0.00000000000000 |
| max(ρ) = ρ₂ | 4.47269469386977 |
| C₀ | 10.00003505749013 |
| C₁ | −0.00189668384925 |
| C₂ | 0.37790989589881 |
| C₃ | −0.02972041915925 |
| C₄ | −0.14122544848115 |
| C₅ | 0.12662515769595 |
| C₆ | −0.05835042345304 |
| C₇ | 0.01632684579355 |
| C₈ | −0.00278408836226 |
| C₉ | 0.00026642351529 |
| C₁₀ | −0.00001097924675 |

FIG. 13 shows the relation between the real object distances D and the corresponding image distances d on the image sensor in the imaging system in accordance with the first embodiment of the present invention. The real object distances D and the corresponding image distances d are obtained from the Equations 25 and 24, respectively. The graph in FIG. 13 is obtained under the assumptions that the focal length of the refractive lens is 6 mm and the heights from the objects to the nodal point N are 1 m, 2 m and 3 m, respectively. From FIG. 13, it can be seen that the distances D of the real objects and the distances d of the images captured on the image sensor have relatively good linear relations. Therefore, it is expected that the image distortion due to the finite (i.e., non-zero) size of the mirror will not be significant for practical purposes.

In the first embodiment of the present invention, it is assumed that the maximum nadir angle δ₂ of the incident ray is larger than the maximum zenith angle θ₂ of the reflected ray, and thus the FOV of the whole imaging system becomes larger than the FOV of the camera itself. But, a reverse case can be considered. For example, if it is assumed that the maximum nadir angle δ₂ of the incident ray is smaller than the maximum zenith angle θ₂ of the reflected ray, the FOV of the whole imaging system becomes smaller than the FOV of the camera itself. In this case, if the maximum axial radius ρ₂ of the mirror is large and the maximum nadir angle δ₂ of the incident ray is very small, the imaging system can be used as a telescope. Therefore, it is not necessarily mandatory that the maximum nadir angle δ₂ of the incident ray is larger than the maximum zenith angle θ₂ of the reflected ray, and the reverse case can be also useful for some applications.

### Second Embodiment

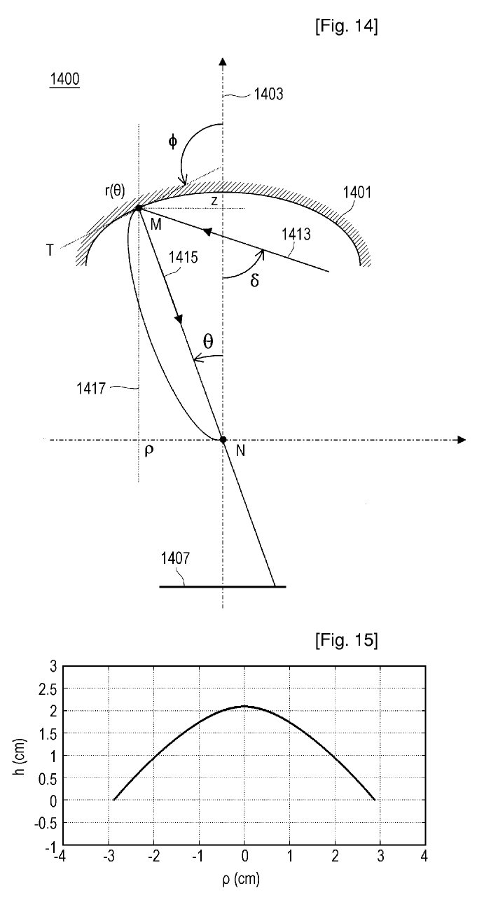

FIG. 14 is a schematic diagram illustrating an imaging system 1400 including a concave rectilinear wide-angle mirror 1401 and an image sensor 1407 in accordance with the second embodiment of the present invention. Contrary to the first embodiment of the present invention, the surface profile of the mirror in accordance with the second embodiment of the present invention is concave. Variables shown in FIG. 14 have one-to-one correspondences to those in FIG. 8. However, there are minor differences in the definition of the zenith angle θ of the reflected ray and the zenith angle φ of the tangent plane, and thus equations defining the profile of the mirror surface in the second embodiment are slightly different from those defining the profile of the mirror surface in the first embodiment.

The surface profile of the rectilinear wide-angle mirror in accordance with the second embodiment of the present invention can be expressed as a distance r from the nodal point N to an arbitrary mirror point M as a function of the zenith angle θ as given in the Equation 32.
r=r(θ) MathFigure 32

Here, zenith angle θ becomes an independent variable and distance r becomes a dependent variable.

Also, the two variables (ρ, z) in the cylindrical coordinate can be expressed in terms of the independent variable θ in the spherical coordinate as given in the Equations 33 and 34.
z(θ)=r(θ)cos θ MathFigure 33
ρ(θ)=−r(θ)sin(θ) MathFigure 34

Note that Equation 34 and Equation 13 have different signs.

The zenith angle φ of the tangent plane T at an arbitrary point M on the mirror surface is given as the Equation 35.

$$tan ϕ = \frac{ⅆ ρ}{ⅆ z} \qquad MathFigure 35$$

As indicated in FIG. 14, the zenith angle φ of the tangent plane T at the point M on the mirror surface 1401, the nadir angle δ of an incident ray 1413, and the zenith angle θ of the reflected ray 1415 satisfy the following relation given in the Equation 36.

$$ϕ = \frac{θ + π + δ}{2} \qquad MathFigure 36$$

Finally, the profile of the mirror surface can be given as the following Equation 37.

$$r ( θ ) = r ( 0 ) exp [ {\int }_{0}^{θ} \frac{sin {θ}^{′} + cot ϕ ( {θ}^{′} ) cos {θ}^{′}}{cos {θ}^{′} - cot ϕ ( {θ}^{′} ) cos {θ}^{′}} ⅆ {θ}^{′} ] \qquad MathFigure 37$$

Equation 37, defining the profile of a concave mirror surface, is the same as the Equation 21 defining the profile of a convex mirror surface.

FIG. 15 shows the profile of a concave wide-angle mirror surface obtained using the Equation 37. The surface profile of the concave rectilinear wide-angle mirror in FIG. 15 is obtained under the assumptions that the maximum zenith angle θ₂ of the reflected ray is 20.0°, the maximum nadir angle δ₂ of the incident ray is 80.0°, and the distance from the nodal point N of the camera lens to the highest point of the mirror (i.e., r=r(θ=0)=zₒ) is 10.0 cm. Plotted in FIG. 15 is the difference in mirror height obtained by subtracting the height of the lowest point on the mirror surface from the mirror height obtained using the Equation 37. That is, h(ρ)=z(ρ)−z₂.

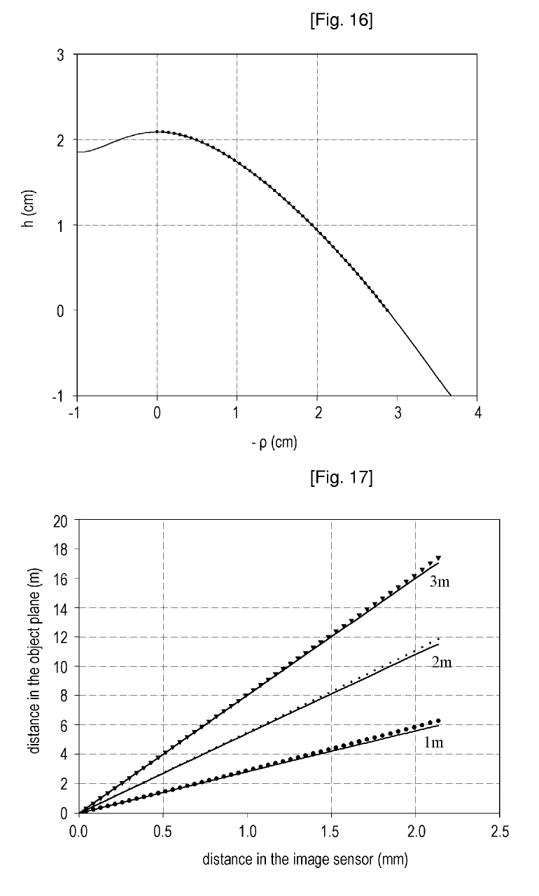

FIG. 16 shows the surface profile of the concave rectilinear wide-angle mirror in FIG. 15 fitted to a 8^{th} order power series in ρ using the least error square method. In FIG. 16, the dotted line shows the profile of mirror surface obtained using the Equation 37 and the solid line shows the fitted result. The minimum order to maintain the errors between the mirror surface profile obtained using the Equation 37 and the fitted result below 1 um is 8. The 8^{th} order power series is given as the following Equation 38.

$$h ( ρ ) = {\sum }_{n = 0}^{8} {C}_{n} ( - {ρ}^{n} ) \qquad MathFigure 38$$

In Equation 38, Cₙ denotes a coefficient of the power series. The following table 2 shows these coefficients.

TABLE 2

| Coefficient | Value |
|---|---|
| min(−ρ) = −ρ₁ | 0.00000000000000 |
| max(−ρ) = −ρ₂ | 2.87929983868249 |
| C₀ | 9.99997527205350 |
| C₁ | 0.00137939832845 |
| C₂ | −0.42429963517536 |
| C₃ | 0.02346062814862 |
| C₄ | 0.10209984417577 |
| C₅ | −0.07951187181758 |
| C₆ | 0.02899508059194 |
| C₇ | −0.00543330709599 |
| C₈ | 0.00041804108067 |

FIG. 17 shows the relation between the real object distances D and the corresponding image distances d captured on the image sensor in the imaging system in accordance with the second embodiment of the present invention. The real object distances and the corresponding image distances are obtained using the Equations 25 and 24, respectively. The graph in FIG. 17 is obtained under the assumptions the heights from the objects to the nodal point N are 1 m, 2 m and 3 m, respectively. From FIG. 17, it can be seen that the distances of the real objects and the distances of the images captured on the image sensor have relatively good linear relations. Therefore, it is expected that the image distortion due to the finite size of the mirror with either the convex or the concave rectilinear wide-angle mirrors in accordance with the first or the second embodiment of the present invention is not significant.

### Third Embodiment

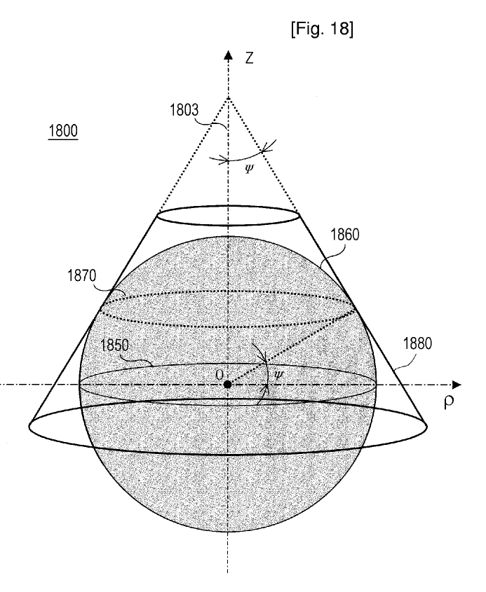

FIG. 18 is a schematic diagram illustrating the projection scheme and the field of view (FOV) of a rectilinear panoramic imaging system in accordance with the third embodiment of the present invention. In this embodiment, a horizon 1850 is envisioned around an observer (not illustrated) located at the coordinate origin O, and a sky vault 1860 having the horizon 1850 as a great circle is further envisioned. Then as shown in FIG. 18, a small circle 1870 can be obtained by connecting the points on the sky vault 1860 having an altitude angle ψ. An altitude angle ψ is an angle measured from the horizon, or the plane perpendicular to the z-axis (i.e., x-y plane) toward the zenith. Then, a cone is envisioned contacting the sky vault 1860 along the perimeter of the small circle 1870. A cone having the small circle 1870 as the collection of tangential points to the sky vault 1860 is uniquely defined, and the rotational symmetry axis 1803 of the cone is perpendicular to the ground (i.e., x-y plane). Also, the half angle of the vertex of the cone is ψ. Then, a virtual screen 1880 of the current embodiment is obtained by removing the upper and the lower parts of the cone, where the removed regions are horizontally (i.e., perpendicular to the symmetry axis 1803) cut-away from the cone. If the altitude angle ψ is 0°, then the virtual screen 1880 has a cylindrical shape tangent to the sky vault 1860 at the horizon 1850. If the altitude angle ψ is smaller than 0°, then the virtual screen 1880 is tangent to the sky vault 1860 underneath the horizon 1850, and virtual screen is gaping toward the zenith (i.e., axial radius of the cone is larger for a higher z). Then, the surface profile of the rectilinear panoramic mirror is designed so that an image on the virtual screen 1880 can be captured on the image sensor as an image having a ring shape.

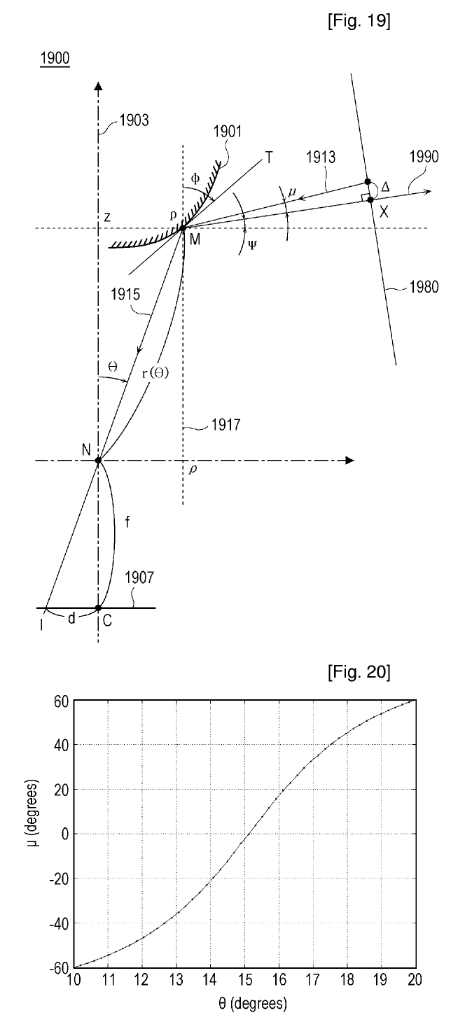

FIG. 19 shows an imaging system 1900 in accordance with the third embodiment of the present invention comprising a rectilinear panoramic mirror and an image sensor. As shown in FIG. 19, the rectilinear panoramic mirror 1901 is facing the ground, and the camera (not shown) is facing the rectilinear panoramic mirror 1901, and the camera and the rectilinear panoramic mirror are relatively fixed to each other by a fixing means and the rectilinear panoramic mirror 1901 has a rotationally symmetric profile about the rotational symmetry axis 1903.

As has been illustrated in FIG. 18, the virtual screen 1880 can be considered as a part of a cone having a vertex half angle ψ. Therefore, as schematically shown in FIG. 19, if a normal 1990 is drawn from an arbitrary point M on the panoramic mirror surface 1901 to the virtual screen 1980, the normal 1990 intersect the virtual screen 1980 at an intersection X with the altitude angle ψ. In this case, the location of the intersection X changes as the point M changes, however the altitude angle ψ does not change.

In this invention, an elevation angle μ is further defined. An elevation angle μ is the angle subtended by the normal 1990 drawn to the virtual screen 1980 and the incident ray 1913 from a point P on the virtual screen 1980 and is measured from the normal toward the zenith (i.e., in the same direction as the altitude angle ψ). Therefore, the incident ray 1913 from the point P on the virtual screen 1980 has an elevation angle μ relative to the normal 1990. The altitude angle ψ of the normal 1990, the elevation angle μ and the nadir angle δ of the incident ray satisfy the following relation.

$$δ = \frac{π}{2} + ψ + μ \qquad MathFigure 39$$

Then, the surface profile of the rectilinear panoramic mirror in accordance with the third embodiment of the present invention is designed so that the distance Δ from the intersection X to the point P on the virtual screen 1980 is approximately proportional to the distance d from the center C of the image sensor 1907 to the pixel I on the image sensor 1907 by which the reflected ray 1915 is captured. Strictly speaking, the surface profile of the rectilinear panoramic mirror is designed so that the tangent of the elevation angle μ of the incident ray 1913, which is measured from the normal 1990, is proportional to the tangent of the zenith angle θ of the reflected ray 1915 passing through the nodal point N of the camera lens. The altitude angle ψ of the normal 1990 is between −π/2 and π/2(−π/2<ψ<π2), and the elevation angle μ of the incident ray ranges from a minimum value μ₁ larger than −π/2 to a maximum value μ₂ smaller than π/2. Here, the elevation angles μ₁ and μ₂ correspond to the minimum zenith angle θ₁ and the maximum zenith angle θ₂ of the reflected rays, respectively. The zenith angle θ of the reflected ray ranges from a minimum value θ₁ larger than zero to a maximum value smaller than π/2(0<θ₁≦θ≦θ₂<π/2). The zenith angle φ of the tangent plane T to the mirror surface at the point M, the zenith angle θ of the reflected ray and the elevation angle μ of the incident ray satisfy the following relation.

$$ϕ = \frac{θ + ( π - δ )}{2} = \frac{θ + ( \frac{π}{2} - ψ - μ )}{2} \qquad MathFigure 40$$

Because the location of the intersection X changes as the location of the point M on the mirror surface changes, it is not possible that the image on the image sensor 1907 is strictly proportional to the image on the virtual screen 1980. Similar to the first and the second embodiments, in order to have the image on the image sensor 1907 be nearly proportional to the image on the virtual screen 1980, the size of the rectilinear panoramic mirror 1901 should be small compared to the distance from the optical axis 1903 to the virtual screen 1980. Within this approximation, the following equation can be obtained for the angular ranges of the incident and the reflected rays.

$$tan μ = \frac{tan {μ}_{2} - tan {μ}_{1}}{tan {θ}_{2} - tan {θ}_{1}} ( tan θ - tan {θ}_{1} ) + tan {μ}_{1} \qquad MathFigure 41$$

Therefore, the elevation angle μ of the incident ray 1913 can be given as a function of the zenith angle θ of the reflected ray 1915 as given in the Equation 42.

$$μ = {tan}^{- 1} [ \frac{tan {μ}_{2} - tan {μ}_{1}}{tan {θ}_{2} - tan {θ}_{1}} ( tan θ - tan {θ}_{1} ) + tan {μ}_{1} ] \qquad MathFigure 42$$

From Equations 40 and 42, the zenith angle q) of the tangent plane T to the mirror surface can be expressed as a function of the zenith angle θ of the reflected ray 1915.

Rest of the derivation relating to a design of the wide-angle mirror shown in FIG. 19 is similar to the one given for the first embodiment of the present invention. Namely, Equations 11 through 18 can be adopted for the current embodiment without any modification, and similar to the Equation 21, the surface profile of the rectilinear panoramic mirror is given by the following Equation 43.

$$r ( θ ) = r ( {θ}_{i} ) exp [ {\int }_{{θ}_{i}}^{ θ} \frac{sin {θ}^{′} + cot ϕ ( {θ}^{′} ) cos {θ}^{′}}{cos {θ}^{′} - cot ϕ ( {θ}^{′} ) sin {θ}^{′}} ⅆ {θ}^{′} ] \qquad MathFigure 43$$

FIG. 20 shows the functional relation between the zenith angle θ of the reflected ray and the elevation angle μ of the incident ray obtained using the Equation 42. Here, the zenith angle θ of the reflected ray ranges from 10° to 20°, and the corresponding elevation angle μ ranges from −π/3 to π/3.

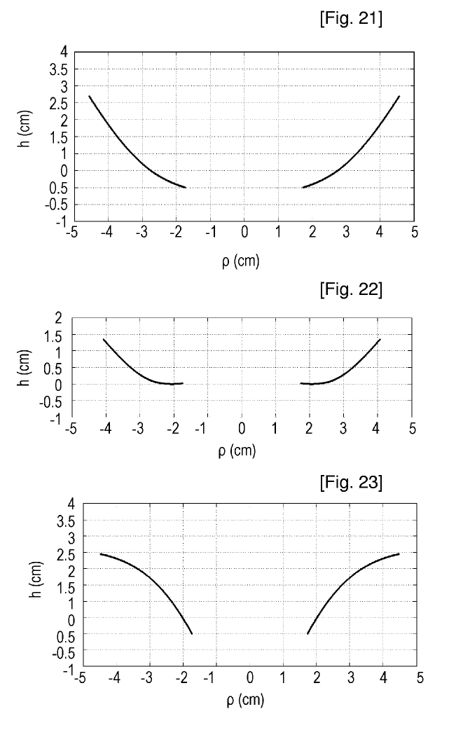

FIG. 21 shows the surface profile of a normal-type rectilinear panoramic mirror for a case where the altitude angle ψ of the normal 1990 drawn to the virtual screen 1980 is 0°, the elevation angle μ of the incident ray ranges from −π/4 to π/4(−π/4=μ₁≦μ≦μ₂=π/4), the zenith angle θ of the reflected ray ranges from 10° to 20° (10°=θ₁≦θ≦θ₂=20°), and the minimum distance r(θ₁) from the nodal point N to the mirror surface is 10 cm (r(θ₁)=10.0 cm). A mirror having the surface profile shown in FIG. 21 can be adapted to a panoramic imaging system capable of mapping images within ±45° view from the horizon on a cylindrically-shaped virtual screen surrounding an observer into a ring-shaped image on the image sensor.

FIG. 22 shows the surface profile of a rectilinear panoramic mirror for a case where the altitude angle ψ of the normal 1990 drawn to the virtual screen 1980 is −π/6, the elevation angle μ of the incident ray ranges from −π/3 to π/3 (−π/3=μ₁≦μ≦μ₂=π/3), the zenith angle θ of the reflected ray ranges from 10° to 20° (10°=θ₁≦θ≦θ₂=20°), and the minimum distance r(θ₁) from the nodal point N to the mirror surface is 10.0 cm (r(θ₁)=10.0 cm). A mirror having the surface profile shown in FIG. 22 can be adapted to a panoramic imaging system capable of capturing a panoramic image of objects within ±60° view with the observer's eye inclined downward from the horizon by 30°. The image captured with this panoramic imaging system is similar to an image taken on an observation platform or a watchtower.

FIG. 23 shows the surface profile of an inverting-type rectilinear panoramic mirror for a case where the altitude angle ψ of the normal 1990 drawn to the virtual screen 1980 is 0°, the elevation angle μ of the incident ray ranges from −π/4 to π/4 (π/4=μ₁≧μ≧μ₂=−π/4), the zenith angle θ of the reflected ray ranges from 10° to 20° (10°=θ₁≦θ≦θ₂=20°), and the minimum distance r(θ₁) from the nodal point N to the mirror surface is 10.0 cm (r(θ₁)=10.0 cm). A mirror having the surface profile shown in FIG. 23 can be adapted to a panoramic imaging system capable of capturing a panoramic image of objects within ±45° view from the horizon. In the case of using a normal-type panoramic mirror as is shown in FIG. 21, the image of an object lying on the horizon is closer to the inner hoop of the ring-shaped image than that of an object lying above the horizon, whereas in the case of using an inverting-type panoramic mirror as is shown in FIG. 23, the image of an object lying on the horizon is closer to the outer hoop of the ring-shaped image. In other words, an image captured with the panoramic mirror shown in FIG. 23 becomes that of FIG. 21 when the ring-shaped image is inverted inside out.

### Fourth Embodiment

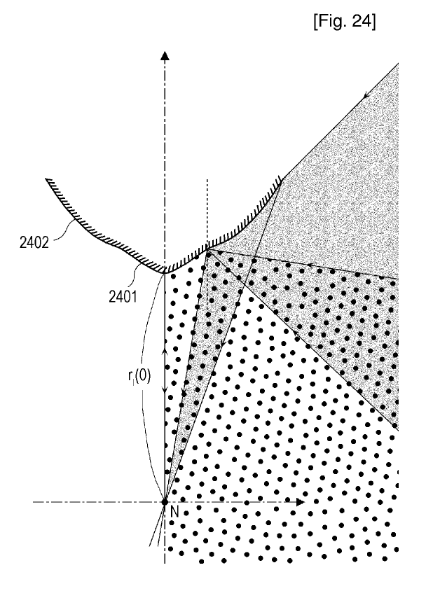

FIG. 24 shows an imaging system comprising a complex mirror, which combines the convex rectilinear wide-angle mirror shown in FIG. 11 and the normal-type rectilinear panoramic mirror shown in FIG. 21. The surface profile 2401 of the convex rectilinear wide-angle mirror in the inner region is given by the following Equation 44.

$${r}_{I} ( {θ}_{I} ) = {r}_{I} ( 0 ) exp [ {\int }_{0}^{{θ}_{I}} \frac{sin {θ}^{′} + cot {ϕ}_{I} ( {θ}^{′} ) cos {θ}^{′}}{cos {θ}^{′} - cot {ϕ}_{I} ( {θ}^{′} ) sin {θ}^{′}} ⅆ {θ}^{′} ] \qquad MathFigure 44$$

Except for the nomenclature, Equation 44 is identical to the Equation 21. Namely, in the Equation 44, r_{I}(θ_{I}) denotes the radial distance from the nodal point N of the camera to a point on the wide-angle mirror surface 2401 having a zenith angle θ_{I}, and r_{I}(0) is the radial distance from the nodal point N to the lowest point on the wide-angle mirror surface 2401 (i.e., the intersection between the wide-angle mirror surface 2401 and the rotational symmetry axis). The zenith angle θ_{I} of the reflected ray ranges from the minimum zenith angle 0 to a maximum zenith angle θ_{I2} smaller than π/2(0<θ_{I}<θ_{I2}<π/2). The nadir angle δ_{I} of the incident ray propagating toward the wide-angle mirror surface 2401 ranges from the minimum nadir angle 0 to a maximum nadir angle δ_{I2} smaller than π/2 (0≦δ_{I}<δ_{I2}<π/2). The nadir angle δ_{I} of the incident ray is a function of the zenith angle θ_{I} of the reflected ray as given in the Equation 45.

$${δ}_{I} ( {θ}_{I} ) = {tan}^{- 1} ( \frac{tan {δ}_{I 2}}{tan {θ}_{I 2}} tan {θ}_{I} ) \qquad MathFigure 45$$

Further, the zenith angle φ_{I}(θ_{I}) of the tangent plane to the wide-angle mirror surface 2401 can be expressed as the following Equation 46.

$${ϕ}_{I} ( {θ}_{I} ) = \frac{{θ}_{I} + ( π - {δ}_{I} )}{2} \qquad MathFigure 46$$

The surface profile 2401 of the convex rectilinear wide-angle mirror in the inner region of the complex mirror has been obtained by using the Equations 44 through 46 under the assumptions that the maximum zenith angle θ_{I2} of the reflected ray is 10.0°, the maximum nadir angle δ_{I2} of the incident ray is 80.0°, and the radial distance from the nodal point N to the lowest point (i.e., r_{I}=r_{I}(θ_{I}=0)) on the mirror surface 2401 is 10.0 cm. Here, subscript ‘I’ denotes the inner region.

The profile of the normal-type rectilinear panoramic mirror surface 2402 in the outer region of the complex mirror is given by the following Equation 47.

$${r}_{O} ( {θ}_{O} ) = {r}_{O} ( {θ}_{Oi} ) exp [ {\int }_{{θ}_{Oi}}^{{θ}_{O}} \frac{sin {θ}^{′} + cot {ϕ}_{O} ( {θ}^{′} ) cos {θ}^{′}}{cos {θ}^{′} - cot {ϕ}_{O} ( {θ}^{′} ) sin {θ}^{′}} ⅆ {θ}^{′} ] \qquad MathFigure 47$$

In the Equation 47, r_{O}(θ_{O}) is the radial distance from the nodal point N to a point on the panoramic mirror surface 2402 having a zenith angle θ_{O}, and r_{O}(θ_{Oi}) is the radial distance from the nodal point N to another point on the panoramic mirror surface 2402 having a zenith angle θ_{Oi}. The zenith angle θ_{O} of the reflected ray ranges from a minimum zenith angle θ_{O1} no less than θ_{I2} to a maximum zenith angle θ_{O2} smaller than π/2 (θ_{I2}≦θ_{O}≦θ_{O2}≦π/2). The elevation angle μ_{O} of the incident ray ranges from a minimum elevation angle μ_{O1} larger than −π/2 to a maximum elevation angle μ_{O2} smaller than π/2, and is a function of the zenith angle θ_{O} of the reflected ray as given in the Equation 48.

$${μ}_{O} ( {θ}_{O} ) = {tan}^{- 1} [ \frac{tan {μ}_{O 2} - tan {μ}_{O 1}}{tan {θ}_{O 2} - tan {θ}_{O 1}} ( tan {θ}_{O} - tan {θ}_{O 1} ) + tan {μ}_{O 1} ] \qquad MathFigure 48$$

Also, the zenith angle φ_{O}(θ_{O}) of the tangent plane to the panoramic mirror surface 2402 is a function of the zenith angle θ_{O} of the reflected ray as shown in the following Equation 49.

$${ϕ}_{O} ( {θ}_{O} ) = \frac{{θ}_{O} + \frac{π}{2} - ψ - {μ}_{O} ( {θ}_{O} )}{2} \qquad MathFigure 49$$

The surface profile 2402 of the normal-type rectilinear panoramic mirror at the outer region of the complex mirror shown in FIG. 24 has been obtained by using the Equations 47 through 49. The altitude angle ψ of a normal drawn to the virtual screen related to the panoramic mirror in the outer region is zero, the elevation angle μ_{O} of the incident ray ranges from −4/π to 4/π (−45°=μ_{O1}≦μ_{O}≦μ_{O2}=45°), and the zenith angle θ_{O} of the reflected ray ranges from 10° to 20° (10°=θ_{O1}≦θ_{O}≦θ_{O2}=20°). Here, the subscript ‘O’ denotes the outer region. The minimum radial distance r_{O}(θ_{O1}) from the nodal point N of the camera to the surface of the normal-type rectilinear panoramic mirror 2402 at the outer region of the complex mirror is identical to the maximum distance r_{I}(θ_{I2}) from the nodal point N of the camera to the surface of the convex-type rectilinear wide-angle mirror 2401 at the inner region.

By using a complex mirror, it is easy to monitor a vast area because a wide-angle planar image and a panoramic image are simultaneously obtained, where the wide-angle planar image obtainable from the inner region of the complex mirror is similar to an image one can obtain by looking down from a high place, and the rectilinear panoramic image obtainable from the outer region of the complex mirror provides images from every directions (i.e., 360°) in the horizonontal plane. Furthermore, if the imaging system is set up on a moving object, for example as to protrude from the roof of an automobile, an airplane, a mobile robot and so on, then an aerial image containing the moving object and the surroundings thereof can be obtained using the wide-angle mirror at the inner region of the complex mirror. Therefore, imaging system comprising the complex mirror shown in FIG. 24 can be used in many different application areas, such as the collision avoidance of autonomous robots/unmanned vehicles, distance measurement of nearby objects while backing up or parking a car, or remote surveillance using a cellular phone. On the other hand, an image of every direction (i.e., 360°) in the horizontal plane is obtained from the rectilinear panoramic mirror at the outer region of the complex mirror. Therefore distant obstacles as well as other moving objects approaching from a side and from the back can be all detected in time and collision can thus be avoided.

### Fifth Embodiment

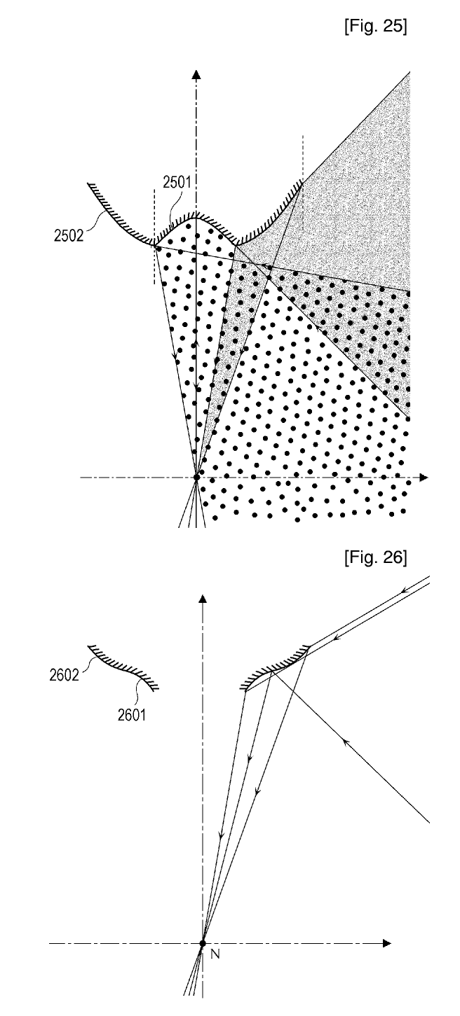

FIG. 25 shows an imaging system comprising another complex mirror. The complex mirror in FIG. 25 includes a concave rectilinear wide-angle mirror 2501 at the inner region and a normal-type rectilinear panoramic mirror 2502 at the outer region. While the rectilinear wide-angle mirror of the fourth embodiment is a convex mirror, the rectilinear wide-angle mirror of the fifth embodiment is a concave mirror. Besides this, the ranges of the nadir angle of the incident ray and the zenith angle of the reflected ray for the mirrors 2501 and 2502 are identical to those of mirrors 2401 and 2402 in FIG. 24.

### Sixth Embodiment

FIG. 26 shows a stereovision system including a double rectilinear panoramic mirror in accordance with the sixth embodiment of the present invention. The double rectilinear panoramic mirror includes a first panoramic mirror surface 2601 at the inner region and a second panoramic mirror 2602 at the outer region. The first panoramic mirror surface 2601 is an inverting-type panoramic mirror and the second panoramic mirror 2602 is a normal-type panoramic mirror. Two altitude angles ψ_{I} and ψ_{O} of the respective normals drawn to virtual screens related to the first and the second panoramic mirror surfaces 2601 and 2602 are both zero (ψ_{I}=ψ_{O}=0°). Elevation angles of the incident rays for the two mirrors have the same range (μ_{I1}=μ_{O2}, μ_{I2}=μ_{O1}). The first and the second panoramic mirrors 2601 and 2602 are designed so that the elevation angle of the incident ray for the first panoramic mirror 2601 ranges from 30° to −45° (i.e., μ_{I1}=30° and μ_{I2}=−45°), the elevation angle of the incident ray for the second panoramic mirror 2602 ranges from −45° to 30° (i.e., μ_{O1}=−45° and μ_{O2}=30°), the zenith angle of the reflected ray for the first panoramic mirror 2601 ranges from 10° to 15° (i.e., θ_{I1}=10° and θ_{I2}=15°), the zenith angle of the reflected ray for the second panoramic mirror 2602 ranges from 15° to 20° (i.e., θ_{O1}=15° and θ_{O2}=20°), the minimum radial distance r_{I1} from the nodal point N of the camera to the lowest point on the first panoramic mirror 2601 is 10.0 cm (i.e., r_{I1}=10.0 cm), and the minimum radial distance r_{O1} from the nodal point N to the lowest point on the second panoramic mirror 2602 is identical to the maximum distance r_{I2} from the nodal point N to the first panoramic mirror 2601 (r_{O1}=r_{O}(θ_{O1})=r_{I2}=r_{I}(θ_{I2})). As mentioned previously, subscripts ‘I’ and ‘O’ denote the inner and the outer regions, respectively.

The double rectilinear panoramic mirror can be more easily produced and maintained when the inner mirror is an inverting-type and the outer mirror is a normal-type because, as schematically shown in FIG. 26, the two mirrors are smoothly joined at the transition region.

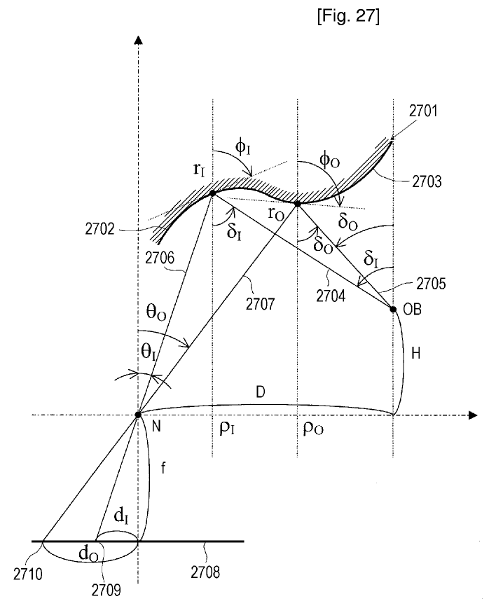

As schematically shown in FIG. 27, when a double panoramic mirror 2701 including an inverting-type panoramic mirror 2702 and a normal-type panoramic mirror 2703 is used, then incident rays 2704 and 2705 originating from an object point OB are respectively reflected on the inverting-type panoramic mirror 2702 and the normal-type panoramic mirror 2703, and then the reflected rays 2706 and 2707 are captured by the pixels at the points 2709 and 2710 on the image sensor 2708, where the distances from the optical axis are d_{I} and d_{O}, respectively. The object point OB is located at a distance (axial radius) D from the optical axis, and at a height H from the nodal point N. Here, it is assumed that the incident rays 2704 and 2705 have nadir angles δ_{I} and δ_{O}, and the reflected rays 2706 and 2707 have zenith angles θ_{I} and θ_{O}, respectively. Therefore, the zenith angle θ_{I} of the reflected ray 2706 captured by the pixel at the point 2709 at a distance d_{I} from the center of the image sensor 2708 can be calculated as the following Equation 50.

$${θ}_{I} = {tan}^{- 1} ( \frac{{d}_{I}}{f} ) \qquad MathFigure 50$$

Similarly, the zenith angle θ_{O} of the reflected ray 2707 captured by the pixel at the point 2710 at a distance d_{O} from the center of the image sensor 2708 can be calculated as the following Equation 51.

$${θ}_{O} = {tan}^{- 1} ( \frac{{d}_{O}}{f} ) \qquad MathFigure 51$$

From the two zenith angles θ_{I} and θ_{O}, the two distances r_{I}(θ_{I}) and r_{O}(θ_{O}) for the two mirror points where the two reflected rays 2706 and 2707 have been respectively reflected can be known and the two nadir angles δ_{I} and δ_{O} of the incident rays 2704 and 2705 can be also obtained.

From the geometrical structure shown in FIG. 27, the following relation can be derived with respect to the reflected ray 2706 reflected on the inverting-type inner panoramic mirror 2702.
r_{I} cos θ_{I}=H+(D−ρ_{I})cot δ_{I} MathFigure 52

In the same manner, the following relation can be derived with respect to the reflected ray 2707 reflected on the normal-type outer panoramic mirror 2703.
r_{O} cos θ_{O}=H+(D−ρ_{O})cot δ_{O} MathFigure 53

From the Equations 52 and 53, the horizontal distance D and the height H can be uniquely determined as shown in the Equations 54 and 55.

$$\begin{matrix}D = \frac{( \begin{matrix}{r}_{O} cos {θ}_{O} - \\ {r}_{I} cos {θ}_{I}\end{matrix} ) + ( \begin{matrix}{ρ}_{O} cot {δ}_{O} - \\ {ρ}_{I} cot {δ}_{I}\end{matrix} )}{cot {δ}_{O} - cot {δ}_{I}} & MathFigure 54 \\ H = \frac{( \begin{matrix}{r}_{I} cos {θ}_{I} cot {δ}_{O} - \\ {r}_{O} cos {θ}_{O} cot {δ}_{I}\end{matrix} ) - ( \begin{matrix}{ρ}_{O} - \\ {ρ}_{I}\end{matrix} ) cot {δ}_{O} cot {δ}_{I}}{cot {δ}_{O} - cot {δ}_{I}} & MathFigure 55\end{matrix}$$

Therefore, three-dimensional position information of the object point can be acquired with a double panoramic mirror. Also, the double panoramic mirror can be adapted to a panoramic rangefinder.

### Seventh Embodiment

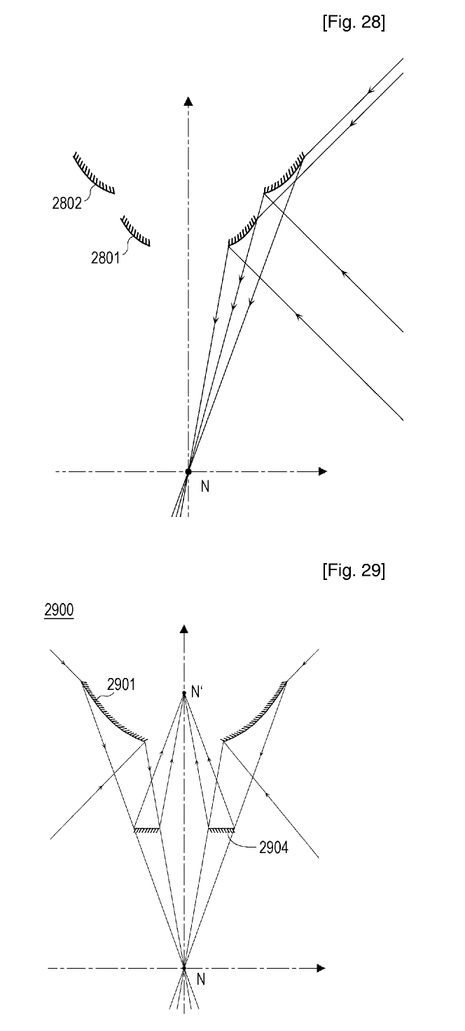

FIG. 28 shows another stereovision system including a double panoramic mirror implementing the rectilinear projection scheme in accordance with the seventh embodiment of the present invention. The double panoramic mirror includes two normal-type rectilinear panoramic mirrors, and the two altitude angles of the respective normals drawn to the virtual screens related to the first and the second panoramic mirror surfaces 2801 and 2802 are both zero (ψ_{I}=ψ_{O}=0°), and the two elevation angles of the incident rays for the two mirrors have a common range ranging from −45° to 45° (μ_{I1}=μ_{O1}=−45°, μ_{I2}=μ_{O2}=45°). The zenith angle of the reflected ray for the first panoramic mirror surface 2801 ranges from 10° to 15° (θ_{I1}=10°, θ_{I2}=15°), the zenith angle of the reflected ray for the second panoramic mirror 2802 ranges from 15° to 20° (θ_{O1}=15°, θ_{O2}=20°), and the minimum radial distance r_{I1} from the nodal point N of the camera to the first panoramic mirror 2801 is 10.0 cm (r_{I1}=10.0 cm). If the two rectilinear panoramic mirrors 2801 and 2802 are adjacent to each other, then the region of the object space that can be imaged with the double panoramic mirror becomes narrower than it is designed for, because the inner panoramic mirror 2801 occludes the view of the outer panoramic mirror 2802 and vice versa. To resolve this problem, as indicated in FIG. 28, the second rectilinear panoramic mirror 2802 at the outer region is displaced along the radial direction, and the minimum radial distance r_{O1} from the nodal point N to the second rectilinear panoramic mirror 2802 is set at 110% of the maximum radial distance r_{I2} from the nodal point N to the first rectilinear panoramic mirror 2801 (i.e., r_{O}(θ_{O1})=1.1×r_{I}(θ_{I2})).

A panoramic stereovision system adopting two rectilinear normal-type panoramic mirrors 2801 and 2802 has drawbacks in terms of size and difficulty in fabrication. However, such a panoramic stereovision system can have a better resolution in distance measurement due to the increased separation between the first and the second panoramic mirrors 2801 and 2802. This is because for a stereovision system using the principle of triangulation, the resolution in the distance measurement for a far-away object is proportional to the separation between the nodal points of two cameras or the viewpoints of the two panoramic mirrors. Needless to say, the stereovision system depicted in FIG. 26 adopting a double panoramic mirror with one inverting-type and one normal-type panoramic mirrors can be improved in resolution using the same technique.

### Eighth Embodiment

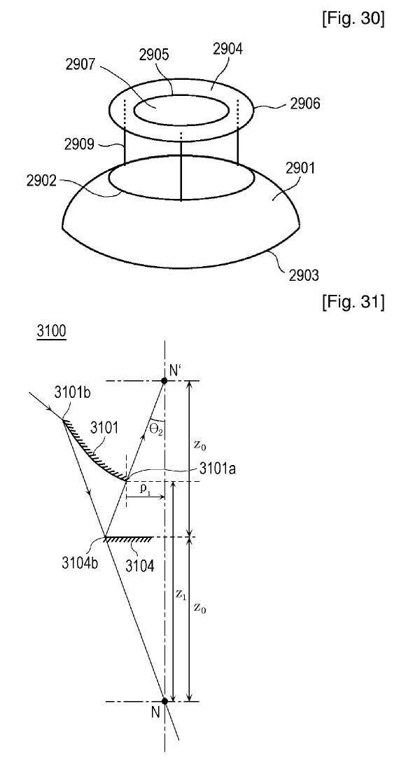

FIG. 29 shows a schematic diagram of a folded rectilinear panoramic imaging system 2900 capable of folding light path with one curved mirror 2901—the rectilinear panoramic mirror as in the third embodiment of the present invention—and one planar mirror 2904. FIG. 30 is a perspective view showing the folded mirror adopting the curved rectilinear panoramic mirror 2901 and the planar mirror 2904. The curved mirror 2901 in FIG. 29 is the rectilinear panoramic mirror illustrated in FIG. 19 and described by the Equation 43. The planar mirror 2904 has a ring shape, that is, the planar mirror 2904 has a concentric inner hoop 2905 and an outer hoop 2906.

Referring to FIG. 30, the curved rectilinear panoramic mirror 2901 and the planar mirror 2904 share a rotational symmetry axis and maintain a predetermined interval along the direction of the rotational symmetry axis. The curved rectilinear panoramic mirror 2901 and the planar mirror 2904 are relatively fixed to each other by using a supporting means 2909. The supporting means 2909 can be a number of posts as has been indicated in the FIG. 30, or it can take the form of a transparent cylinder. When the supporting mean 2909 takes the form of a transparent cylinder, then it is preferable that the cylinder is made of glass, acryl, or other optically clear material.

As schematically shown in FIG. 29, the position of the camera nodal point is changed from N to N′ in a folded rectilinear panoramic imaging system 2900, and the camera (not shown in the figure) is facing the opposite direction. In other words, the camera is aligned toward the negative z-axis instead of the positive z-axis. Also, the optical axis of the camera should coincide with the rotational symmetry axis of the folded mirror and the camera nodal point should be located at the position of the new nodal point N′.

The region within the inner hoop 2905 of the planar mirror 2904 can be a circular hole, or simply a part of the circular mirror not used for imaging. For the latter case, the region within the inner hoop 2905 can be painted in black or treated similarly so that this part of the circular mirror would not reflect light impinging on it. If necessary, a convex lens, a concave lens or a group of lenses can be disposed within the inner hoop of the planar mirror in order to change either the FOV seen thorough the inner hoop of the planar mirror or the effective focal length of the camera. In this case, the lens or the group of lenses need not be in the same plane as the planar mirror. Rather, it can be disposed along the rotational symmetry axis in front of or behind the planar mirror. Nevertheless, the optical axis of the lens or the group of lenses, the optical axis of the camera, and the rotational symmetry axis of the folded mirror should all coincide. This kind of lens or a group of lenses is usually called as a converter. For example, a group of lenses having a negative focal length for widening the effective field of view of a camera is called as a wide-angle converter.

The principal advantage of a folded rectilinear panoramic imaging system shown in FIGS. 29 and 30 is the fact that the region in the object space imaged by the panoramic imaging system is changed from the back of the camera to the front of the camera. This can be very helpful when the imaging system needs to be installed on the ceiling. In this case, the camera is looking down on the floor, and thus the camera and its peripheral devices can be buried inside the ceiling so as to minimize the protrusion from the ceiling. Therefore, it looks better in appearance and is easier in maintenance. Also, it can be advantageous in an anti-aircraft system where the imaging system is set on the ground to monitor the sky as well as in the field of stellar astronomy.

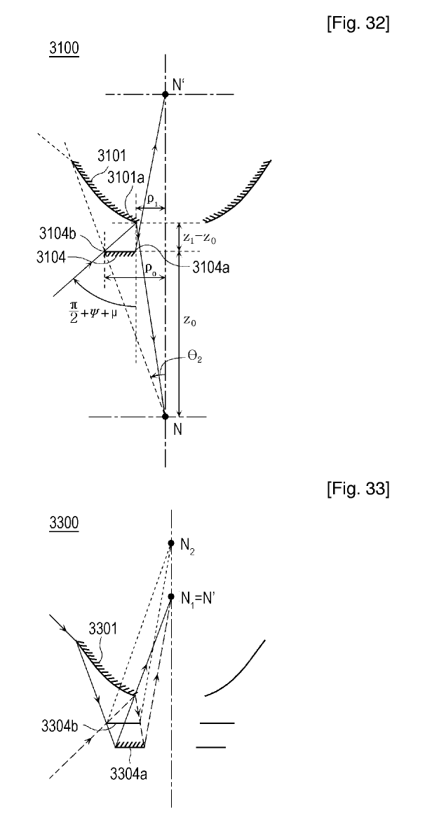

FIGS. 31 and 32 are diagrams illustrating the maximum tolerable range of the planar mirror height z and the sizes ρ_{I} and ρ_{O} of the inner and the outer hoops of the planar mirror 3104 in a folded rectilinear panoramic imaging system 3100. As shown in FIG. 31, the height zₒ from the original nodal point N to the planar mirror 3104 is equal to the height from the planar mirror 3104 to the new nodal point N′. In this case, the permissible minimum interval (z₁−zₒ) between the curved mirror 3101 and the planar mirror 3104 is such that a ray sequentially reflected at the outer hoop 3101b of the curved mirror 3101 and the outer hoop 3104b of the planar mirror 3104 and propagating toward the new nodal point N′ is not occluded by the inner hoop 3101a of the curved mirror 3101. Namely, when the nadir angle of a reflected ray reflected at the outer hoop 3104b of the planar mirror 3104 is θ₂, and the radius of the inner hoop 3101a of the curved mirror 3101 is ρ₁, then the minimum interval (z₁−zₒ) between the curved mirror 3101 and the planar mirror 3014 must satisfy the Equation 56.
(2z_{O}−z_{I})tan θ₂≦ρ_{I} MathFigure 56

Therefore, the maximum height from the original nodal point N to the planar mirror surface 3104 can be given as the following Equation 57.

$${z}_{O}^{( 1 )} = \frac{{ρ}_{1} + {z}_{1} tan {θ}_{2}}{2 tan {θ}_{2}} \qquad MathFigure 57$$

Referring to FIG. 32, a ray sequentially reflected at the inner hoop 3101a of the curved rectilinear panoramic mirror 3101 and at the inner hoop 3104a of the planar mirror 3104 and propagating toward the new nodal point N′ should not be occluded by the outer hoop 3104b of the planar mirror 3104 before the ray is reflected at the inner hoop 3101a of the curved mirror 3101. Since the nadir angle δ₁ of the above ray at the time of reflection at the inner hoop 3101a of the curved mirror 3101 is π/2+ψ+μ₁, the following relation given in the Equation 58 must be satisfied.

$${ρ}_{1} + ( {z}_{1} - {z}_{O} ) tan ( \frac{π}{2} + ψ + {μ}_{1} ) \geq {ρ}_{O} = {z}_{O} tan {θ}_{2} \qquad MathFigure 58$$

Therefore, the maximum height of the planar mirror 3104 satisfying the above-mentioned condition can be given as the following Equation 59.

$${z}_{O}^{( 2 )} = \frac{{ρ}_{1} - {z}_{1} cot ( ψ + {μ}_{1} )}{tan {θ}_{2} - cot ( ψ + {μ}_{1} )} \qquad MathFigure 59$$

Then, an actually permissible maximum height of the planar mirror 3104 must be smaller than the smaller one between the two values given in the Equations 57 and 59.
z_{O}=min(z_{O}⁽¹⁾,z_{O}⁽²⁾) MathFigure 60

If the height from the original nodal point N to the planar mirror 3104 is smaller than the height given by the Equation 60 and the radii of the inner and the outer hoops of the planar mirror are appropriate, then the FOV of the folded panoramic mirror will be identical to the rectilinear panoramic mirror alone. In this case, the inner radius r_{I} of the planar mirror 3104 should be smaller than a radius given by the following Equation 61.
ρ_{I}=z_{O} tan θ₁ MathFigure 61

Also, the outer radius ρ_{O} of the planar mirror 3104 should be larger than a radius given by the following Equation 62.
ρ_{O}—z_{O} tan θ₂ MathFigure 62

FIG. 33 is a schematic diagram illustrating the maximum permissible height of the planar mirror 3304a in a folded rectilinear panoramic imaging system 3300 including a curved rectilinear panoramic mirror 3301 that is identical to the rectilinear panoramic mirror shown in FIG. 21. Namely, the surface profile of the curved rectilinear panoramic mirror 3301 is designed such that the altitude angle ψ of a normal drawn to the virtual screen is 0°, the elevation angle μ of the incident ray ranges from π/4 to π/4 (−π/4=μ₁≦μ≦μ₂=π/4), the zenith angle θ of the reflected ray ranges from 10° to 20° (10°=θ₁≦θ≦θ₂=20°), and the minimum radial distance r(θ_{I}) from the nodal point of the camera to the surface of the curved rectilinear panoramic mirror 3301 is 10.0 cm.

FIG. 33 shows the locations and the sizes of the planar mirrors 3304a and 3304b respectively obtained from the Equations 57 and 59 with the aforementioned ranges of the elevation angle μ of the incident ray and the zenith angle θ of the reflected ray.

Since zₒ⁽¹⁾ is smaller than zₒ⁽²⁾, the maximum height of the planar mirror is determined by the Equation 57. Therefore, the new nodal point is N′=N₁ corresponding to the planar mirror 3304a.

Although the position of the planar mirror can be chosen anywhere between the original nodal point N and zₒ⁽¹⁾, choosing the maximum permissible value has the following two merits. First, the size of the folded panoramic mirror can be minimized. Second, a light blocking means, such as a blind, becomes unnecessary because unnecessary rays cannot pass through the new nodal point N′ when the interval between the curved mirror and the planar mirror takes a minimum value. Therefore, if there is no other special reason, it is desirable to dispose the planar mirror at the height given by the Equation 57.

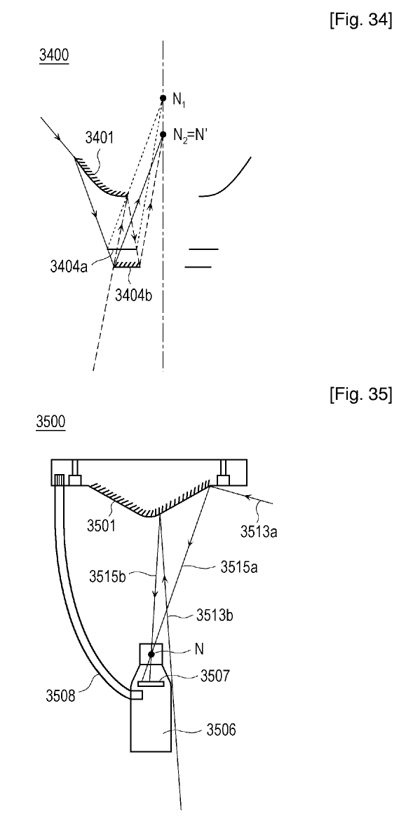

FIG. 34 shows the locations and the sizes of the planar mirror 3404a and 3404b respectively obtained from the Equations 57 and 59 with another ranges of the elevation angle μ of the incident ray and the zenith angle θ of the reflected ray. The surface profile of the curved rectilinear panoramic mirror 3401 is designed such that the altitude angle ψ of a normal drawn to the virtual screen is −20°, the elevation angle μ of the incident ray ranges from −π/3 to π/3 (−π/3=μ₁≦μ≦μ₂=π/3), the zenith angle θ of the reflected ray ranges from 10° to 20° (10°=θ₁≦θ≦θ₂=20°), and the minimum radial distance r(θ_{I}) from the nodal point of the camera to the surface of the curved rectilinear panoramic mirror 3401 is 10.0 cm. As indicated in FIG. 34, the maximum permissible height of the planar mirror is determined by the Equation 59, since zₒ⁽²⁾ is smaller than zₒ⁽¹⁾.

Hereinafter, imaging systems in accordance with the embodiments of the present invention will be described referring to FIGS. 35 through 42.

FIG. 35 shows a conceptual diagram of a wide-angle imaging system adopting the convex rectilinear wide-angle mirror in FIG. 11. The wide-angle imaging system shown in FIG. 35 is set up at a high place such as the ceiling of a building. The rectilinear wide-angle mirror 3501 is disposed to face the floor, and a camera 3506 is disposed to face the rectilinear wide-angle mirror 3501. Preferably, the camera 3506 is a bullet camera. The camera 3506 and the rectilinear wide-angle mirror 3501 are relatively fixed to each other with a supporting means 3508 so that a predetermined interval can be maintained between the rectilinear wide-angle mirror 3501 and the nodal point N of the camera 3506. The rectilinear wide-angle mirror 3501 can receive an incident ray 3513a having a maximum nadir angle 80.0°. This ray 3513a is reflected at the edge of the rectilinear wide-angle mirror 3501, and the corresponding reflected ray 3515a having a zenith angle 20.0° passes through the nodal point of the camera and is captured by the image sensor 3507.

Also shown in FIG. 35 is an incident ray 3513b having the minimum permissible nadir angle and the reflected ray 3515b corresponding thereto. An incident ray having a smaller nadir angle than the minimum permissible nadir angle is occluded by the camera body 3506 and cannot reach the rectilinear wide-angle mirror 3501. Therefore, a dead zone exits at the center of the image captured by the image sensor 3507. However, all the four walls and gates and windows can be monitored with this wide-angle imaging system 3500, and a small dead zone at the center of the captured image is relatively unimportant in a system intended to monitor any possible intruders. When a small bullet camera such as the one with the camera body thinner than 2.5 cm in diameter is employed, then the dead zone resulting from the occlusion of the view by the camera body can be maintained even smaller.

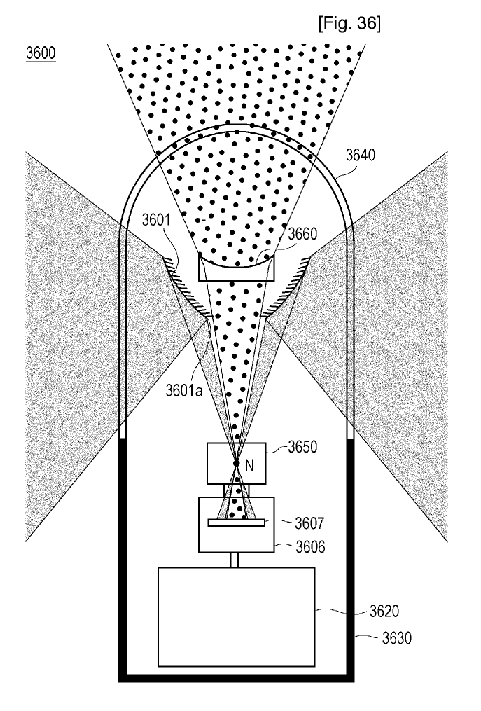

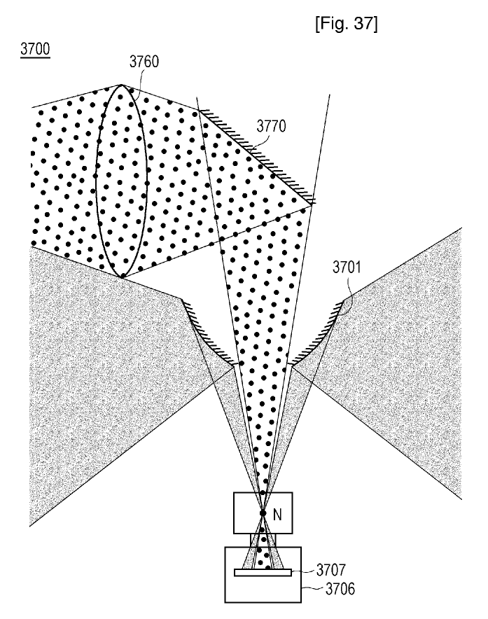

FIG. 36 shows a panoramic imaging system 3600 for simultaneously capturing 360° panoramic image about the rotational symmetry axis of a rectilinear panoramic mirror 3601 and an image with a normal view in front of the rectilinear panoramic mirror 3601. The panoramic imaging system 3600 includes the rectilinear panoramic mirror 3601, a lens 3660 or a group of lenses disposed near the center of the rectilinear panoramic mirror 3601. The optical axis of the lens or a group of lenses 3660, the rotational symmetry axis of the rectilinear panoramic mirror 3601 and the optical axis of the camera lens 3650 all coincide. The lens 3660 can be a wide-angle converter having a negative focal length to expand the effective field of view, or a tele-converter for capturing a detailed image of a far-way object. However, in order to form a real image on the image sensor 3607, the complex lens that is composed of the converter lens 3660 and the refractive lens 3650 as a whole should have a positive refractive power.

As mentioned above, by actively using the hole inside of the inner hoop of the panoramic mirror 3601, an image with a normal view can be captured at the center of the image sensor 3607 much like an image captured by a conventional camera, and a ring-shaped panoramic image can be captured around the image with a normal view. Namely, the image sensor 3607 can have a first image-sensing region having a circular shape, on which an image with a normal view is captured by the rays that went through the converter lens, and a second image sensing region having a ring shape on which a ring-shaped image is captured by the reflected rays reflected at the panoramic mirror surface.

Even if the converter lens 3660 does not exits inside of the inner hoop of the panoramic mirror, an image with a normal view seen through the center hole of the panoramic mirror is captured at the center of the image sensor. However the image will be out of focus, because the refractive lens 3650 must be adjusted to capture a sharp panoramic image with the rays reflected at the rectilinear panoramic mirror 3601. This problem can be resolved by disposing a lens or a group of lenses near the center hole of the panoramic mirror 3601. If the refractive powers of the camera lens 3650 and the converter lens 3660 are P₁ and P₂, respectively, and the spacing between the two lenses is t then the effective refractive power P_{T} of the complex lens as a whole is given by the following Equation 63.
P_{T}=P₁+P₂−tP₁P₂ MathFigure 63

Therefore, for a given refractive powers of the camera lens 3650 and the converter lens 3660, the spacing t between the two lenses (i.e., the position of the converter lens 3660) can be adjusted in order to obtain an image with the normal view in sharp focus.

On the other hand, if the refractive power of the converter lens is stronger than what is necessary to form a sharp image, then an additional effect of FOV conversion can be obtained. In other words, the effective FOV of the image with the normal view can be increased or decreased by arranging the refractive power of the converter lens 3660 to have an appropriate positive or negative value. In a case the FOV is increased, the FOV of the image seen through the center hole of the panoramic mirror 3601 may match or even exceed the FOV of the refractive lens 3650 in the absence of the panoramic mirror 3601. In a case the FOV is decreased, on the other hand, image seen through the center hole can be similar to an image obtainable with a telescope for viewing a far-away object.

This complex imaging system can be of better use when it has a structure schematically shown in FIG. 36. For example, a capsule camera or a video pill for capturing images of digestive duct of human and animal such as the gullet and the small intestine is drawing a keen attention. A capsule camera can have the shape of a medicine pill measuring as small as 1.1 cm in diameter and 2.5 cm in length. A typical capsule camera comprises a camera, a lighting unit for illumination, a control circuit, a battery, and a wireless communication system for sending the captured images outside of the live body. The main purpose of the capsule camera is to capture detailed images of the intestinal wall through which the capsule camera passes. However, the conventional capsule camera cannot capture the part of the intestinal wall just beside thereof, which is most interested, even though the capsule camera can capture the intestinal wall ahead thereof, because the optical axis of the camera installed within the capsule camera is aligned along the direction of the intestine. This problem can be resolved by using an imaging system adopting a panoramic mirror as schematically shown in FIG. 36. The imaging system in accordance with the embodiment of the present invention is housed within a capsule comprising a capsule body 3630 and a transparent dome-shaped window 3640, and includes a camera 3606, a panoramic mirror 3601, an illumination unit, a control circuit, a battery, a wireless communication unit 3620, and a lens or a group of lenses 3660 in front of the camera.

The optical system shown in FIG. 36 can be used to capture not only the images of intestinal wall but also the images of a narrow tunnel, a pipeline and so on. For example, an imaging system is also available for capturing images of an excavation hole that had been dug up in order to explore underground water or mineral resources, and further the imaging system can be used in endoscopies or endoscopic robots for capturing inside images of a pipeline for water supply/drainage or a boiler. For this, the imaging system can be further comprised of an extending means such as rope or chain and electrical wires. The extending means can be used to lower the imaging system within a vertical excavation hole, and to draw out the imaging system out of pipelines, for example. On the other hand, the electrical wires can be used for sending control signals to the imaging system and extracting acquired images.

It is desirable that the panoramic mirror adapted to the panoramic imaging system has a hyperbolic surface or a rectilinear panoramic mirror surface as is described in the third embodiment of the present invention. If a hyperbolic surface having a hole at the center thereof is selected as the panoramic mirror profile, then it must be ensured that the second focal point of the hyperbolic surface is located at the position of the camera nodal point. Then, an incident ray propagating toward the first focal point of the hyperbolic surface is reflected on the hyperbolic mirror surface and the corresponding reflected ray passes through the second focal point of the hyperbolic surface the same as the camera nodal point by construction and finally captured by the image sensor. Since this imaging system having a hyperbolic mirror is a system with a single effective viewpoint, there is no image distortion resulting from changing viewpoints. Therefore, it is possible to obtain a precise image after a due image processing by software. However, it is inevitable that the image resolution varies as the nadir angle of the incident ray varies.

On the other hand, using the rectilinear panoramic mirror illustrated in FIG. 19, a satisfactory image can be obtained with only a minimum amount of image processing (i.e., a polar-to-rectangular transformation of coordinates). In this case, however, slight image distortion may occur due to the effective non-single viewpoint. Therefore, depending on the particular application in hand, an appropriate mirror can be chosen between the two mirror types.

Meanwhile, FIG. 37 illustrates a panoramic imaging system 3700 which can be useful in manned and unmanned navigational systems such as automobiles, radio-controlled toys, cleaning robots and so on. Such a panoramic imaging system 3700 generally includes a camera 3706, a panoramic mirror 3701, and a mirror, a prism or a similar means 3770 for folding the light path that enters through the center hole of the panoramic mirror, and a lens or a group of lenses for an additional adjustment in order to obtain an image with the normal view in sharp focus. It is most preferable to utilize this type of imaging system with the camera optical axis aligned perpendicular to the horizontal plane. Since the system obtains images of every direction (i.e., 360°) by means of the images reflected on its panoramic mirror, obstacles or other navigating bodies approaching the system from arbitrary directions can be recognized in advance and an appropriate preventive action can be taken in time. As such, employing the aforementioned panoramic imaging system enables routine navigation through the normal frontal images and simultaneously monitoring the surroundings of the navigation system by analyzing images reflected on the panoramic mirror.

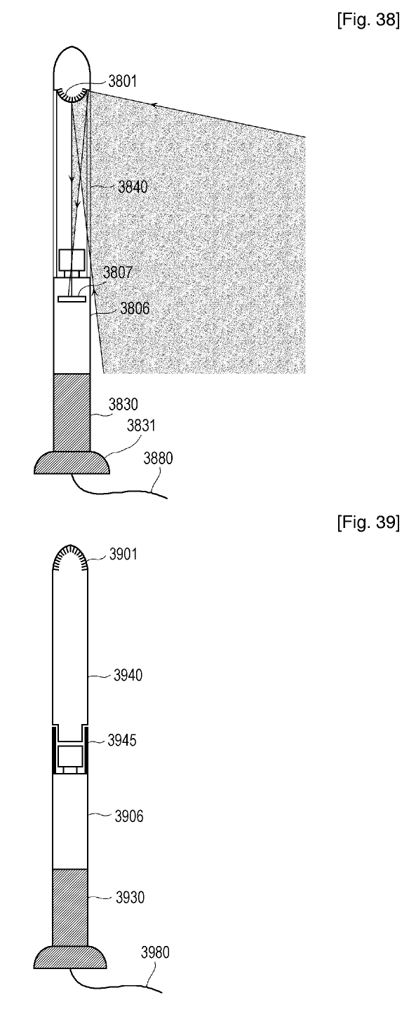

FIG. 38 shows a schematic diagram of an imaging system applicable to automobiles, radio-controlled toys or autonomous robots such as cleaning robots. This type of system employs a narrow long-bodied camera whose diameter is nearly equal to that of its lens, often referred to as a “bullet camera.” Nowadays, bullet cameras having the lens diameter less than 2.5 cm are rather common and a narrower bullet camera is not impossible to manufacture. The rectilinear wide-angled mirror 3801 that is meant to be used with the bullet camera is designed for a relatively small range of the zenith angle of the reflected ray. In FIG. 38, it is assumed that the maximum zenith angle of the reflected ray at the wide-angle mirror is 5°, while the maximum nadir angle of the incident ray is 80°. Also assumed is that the distance from the nodal point of the camera lens to the lowest point on the mirror surface is 15.0 cm. By maintaining a relatively long distance to the wide-angle mirror with a correspondingly small range of the zenith angle of the reflected ray, an image of a vast area can be obtained while maintaining the diameter of the wide-angle mirror smaller than the diameter of the camera body.

The aforementioned wide-angle mirror 3801 and the camera 3806 are relatively fixed to each other by means of a transparent cylindrical member 3840. The transparent cylindrical member can be made of glass or acryl and preferably anti-reflection coated on either one or, more preferably, both the inner and the outer sides of the cylinder. Referring to FIG. 38, the wide-angle mirror is made of metal or mirrorsurfaced glass or plastic and attached to the upper end of the transparent cylindrical member 3840. The camera 3806 is supported with a supporting unit 3830 and the cross-section of the supporting unit perpendicular to the optical axis is smaller than those of the camera lens and the camera body. Herein, one end of the camera body 3806 supported by the supporting unit 3830 is the end at the opposite side of the camera lens and perpendicular to the optical axis of the camera. The supporting unit 3830 can have an extensible structure much like a car radio antenna. For example, the supporting unit 3830 can be made of a number of concentric cylinders, wherein the outer diameter of any one cylinder is smaller than the inner diameter of the adjacent outer cylinder and so on, and each inner cylinder can be inserted into and drawn out of the adjacent outer cylinder. Consequently, the height of the imaging system can be controlled if necessity by collapsing or extending the supporting unit 3830. Furthermore, the supporting unit 3830 can be equipped with an attachment member 3831 in order to attach the imaging system to other objects such as automobiles and cleaning robots. By ensuring that the imaging system contains an uninterrupted conducting wire along the direction of the optical axis (i.e., lengthwise), the imaging system can also function as a radio antenna. Reference numeral 3880 in FIG. 38 are electrical wires for supplying electrical power and retrieving image signals.

FIG. 39 shows a layout of another embodiment of the imaging system shown in FIG. 38. One end of an optically clear cylindrical rod 3940, such as an optical glass or acryl rod, is formed into the shape of the wide-angle mirror and then a mirror surface 3901 is formed by deposition of aluminum or silver. The wide-angle mirror as prepared above is connected to the camera lens by means of a cylindrical supporting member 3945.

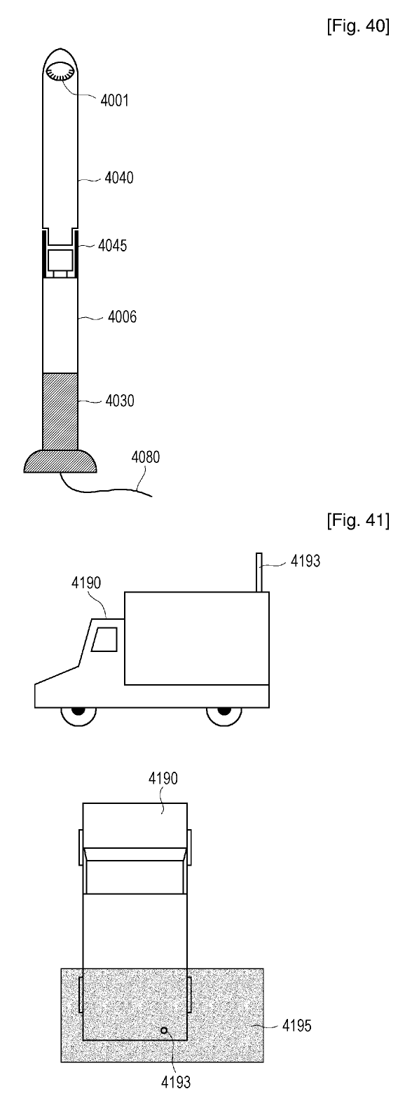

FIG. 40 illustrates another method for manufacturing an imaging system substantially equivalent to the aforementioned imaging systems. The wide-angle mirror 4001 in FIG. 40 is prepared by metal molding, and then insertion-molding the mirror into a transparent cylindrical rod made of acryl or optical glass. This type of wide-angle lens has a lesser risk of damage due to abrasion or mishandling compared to the lens in FIG. 39, and renders mass-production more feasible. To obtain a sharpest image, all the exposed surfaces of the lens such as 3940 in FIGS. 39 and 4040 in FIG. 40 must be properly anti-reflection coated.

FIG. 41 illustrates one exemplary use of the rectilinear wide-angle imaging systems shown in FIGS. 38 through 40. For drivers of buses, trucks and specialized vehicles 4190, it is impossible for them to look at the rear side of the vehicle. In consequence, they are helplessly exposed to dangers of accidents while backing-up or parking the vehicle. To help in alleviating this danger, the aforementioned rectilinear wide-angle imaging system 4193 is installed at the rear end of the vehicle and a video monitor is installed at or near the dashboard so that the driver can monitor the images taken by the wide-angle imaging system while backing-up or parking the vehicle. In this case, the driver can check the video images as if he is looking down the rear of the car from the air, and thus he/she can effectively avoid any obstacles while backing up. Direction of the zone 4195 monitored by the wide-angle imaging system 4193 can be adjusted lengthwise or widthwise with respect to the axle of the car by adjusting the direction of the camera image sensor around the optical axis.

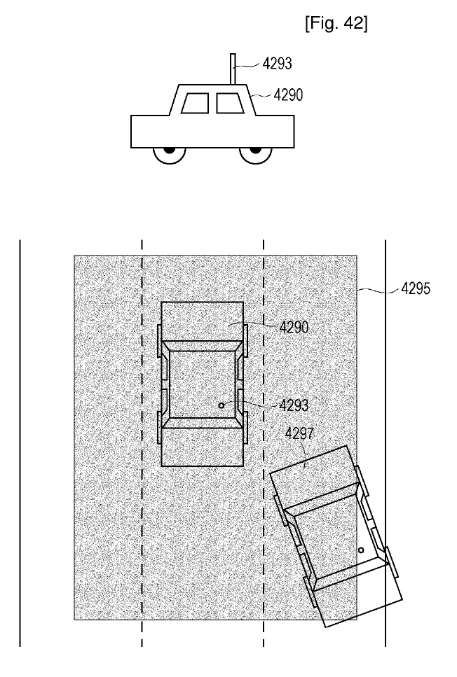

FIG. 42 is a schematic diagram illustrating that the wide-angle imaging system 4293 can be used in various other application areas. For example, the wide-angle imaging system 4293 can be installed at the usual location of a car radio antenna, or at the roof of a car. By ensuring that the height of the wide-angle mirror of the wide-angle imaging system is higher than the highest position of the car by a predetermined amount at the least, the zone monitored by the imaging system can be wide enough to include the entire vehicle within its monitored zone.

Such a wide-angle imaging system capable of obtaining aerial images of the entire car body and its surroundings can be of multiple uses. Foremost of all, this imaging system can be used for avoiding obstacles while backing-up or parking the car. While driving the car, the locations and the speeds of obstacles and other vehicles approaching the car can be comprehended in an intuitively appealing manner, and the chances of accidents can be minimized. This wide-angle imaging system can be also installed on radio-controlled (RC) toys such as cars and helicopters, and the operator can easily maneuver the RC toys even when the RC toys are out of direct sight. Also, maneuvering the RC toys can be as easy as playing video games. This technique can be also applied in the robot industry, for example autonomous robots such as house cleaning robots, and industrial robots working in a harsh and dangerous environment.

Another use of this imaging system is to adapt it to a car black box. Herein, a vehicle is provided with a recording facility for continuously recording images of the vehicle on the road and its surroundings while simultaneously removing oldest images from the recoding medium. In other words, the recoding facility having a predetermined maximum recoding time overwrites the older image with a newer image. Therefore, in a normal operation condition, newer images are over-written on the older images whenever new images are generated, and recording of newer images are stopped when an accident happens. Therefore the most recent images immediately before the car accident is preserved in the recoding medium, and an argument about the cause of the accident can be resolved by analyzing the preserved video images.

Yet another use of this imaging system is in prevention of robbery or vandalism on the car. Herein, images obtained by the wide-angle imaging system can be transmitted to the owner on demand via a wireless Internet or a mobile phone. In addition to that, this system further includes a function of automatically sending images of the car and its surroundings to the owner when an impact over a predetermined threshold is detected (i.e., at an impact time). Needless to say, the owner can check the status of the car using a cellular phone or other appropriate means by requesting wide-angle images of the car whenever he/she is worried about his vehicle.

As mentioned previously, the wide-angle imaging system can take a similar shape as a car radio antenna and able to function as an antenna. Using the same principle as the car radio antenna, the wide-angle imaging system can be buried within the car body when not in use.

While the present invention has been described and illustrated with respect to preferred embodiments of the invention, it will be apparent to those skilled in the art that variations and modifications are possible without deviating from the broad principles and teachings of the present invention which should be limited solely by the scope of the claims appended hereto.

### INDUSTRIAL APPLICABILITY

The present invention enables acquisition of wide-angle and panoramic images comparable to those of fish-eye lenses while simultaneously minimizing the barrel distortion.

1. A mirror, comprising:
a mirror surface having a rotationally symmetric profile about the z-axis in a spherical coordinate, wherein the z-axis has zero zenith angle, and the profile of the mirror surface is described with a set of coordinate pairs (θ, r(θ)) in the spherical coordinate, θ is the zenith angle of a reflected ray reflected at a first point on the mirror surface and passing through the origin of the spherical coordinate, the zenith angle θ ranges from zero to a maximum zenith angle θ₂ less than π/2 (0≦θ<θ₂<π/2), and r(θ) is the corresponding distance from the origin of the spherical coordinate to a first point on the mirror surface and satisfies the following Equation 1:
$$r ( θ ) = r ( 0 ) exp [ {\int }_{0}^{θ} \frac{sin {θ}^{′} + cot ϕ ( {θ}^{′} ) cos {θ}^{′}}{cos {θ}^{′} - cot ϕ ( {θ}^{′} ) sin {θ}^{′}} ⅆ {θ}^{′} ] \qquad ( Equation 1 )$$
where r(0) is the distance from the origin to the intersection between the mirror surface and the z-axis,
the first reflected ray is formed by an incident ray having a nadir angle δ ranging from zero to a maximum nadir angle δ₂ less than π/2 (0≦δ≦δ₂<π/2), the nadir angle δ is a function of the zenith angle θ and satisfies the following Equation 2:
$$δ ( θ ) = {tan}^{- 1} ( \frac{tan {δ}_{2}}{tan {θ}_{2}} tan θ ) \qquad ( Equation 2 )$$
and φ(θ) is the angle subtended by the z-axis and the tangent plane to the mirror surface at the first point, and is a function of θ and δ(θ) as the following Equation 3.
$$ϕ ( θ ) = \frac{θ + π \pm δ ( θ )}{2} \qquad ( Equation 3 )$$

2. A panoramic mirror, comprising:
a mirror surface having a rotationally symmetric profile about the z-axis in a spherical coordinate, wherein the z-axis has zero zenith angle, and the profile of the mirror surface is described with a set of coordinate pairs (θ, r(θ)) in the spherical coordinate, θ is the zenith angle of a first reflected ray reflected at a first point on the mirror surface and passing through the origin of the spherical coordinate, the zenith angle θ ranges from a minimum zenith angle θ₁ larger than zero to a maximum zenith angle θ₂ less than π/2 (0<θ₁≦θ≦θ₂<π/2), and r(θ) is the corresponding distance from the origin of the spherical coordinate to the first point on the mirror surface and satisfies the following Equation 4:
$$r ( θ ) = r ( {θ}_{i} ) exp [ {\int }_{{θ}_{i}}^{θ} \frac{sin {θ}^{′} + cot ϕ ( {θ}^{′} ) cos {θ}^{′}}{cos {θ}^{′} - cot ϕ ( {θ}^{′} ) sin {θ}^{′}} ⅆ {θ}^{′} ] \qquad ( Equation 4 )$$
where θᵢ is the zenith angle of a second reflected ray reflected at a second point on the mirror surface and passing through the origin of the spherical coordinate, and r(θᵢ) is the corresponding distance from the origin to the second point, a normal drawn from the first point to a cone compassing the mirror surface and having the rotational symmetry axis coinciding with the z-axis has an altitude angle ψ, where the altitude angle ψ is measured from the plane perpendicular to the z-axis (i.e., the x-y plane) toward the zenith, the first reflected ray is formed by an incident ray having an elevation angle μ, the elevation angle μ is measured from the normal to the incident ray in the same direction as the altitude angle ψ, both the altitude and the elevation angles are bounded between −π/2 and π/2, the elevation angle μ is a function of the zenith angle θ as the following Equation 5:
$$μ ( θ ) = {tan}^{- 1} [ \frac{tan {μ}_{2} - tan {μ}_{1}}{tan {θ}_{2} - tan {θ}_{1}} ( tan θ - tan {θ}_{1} ) + tan {μ}_{1} ] \qquad ( Equation 5 )$$
and φ(θ) is the angle subtended by the z-axis and the tangent plane to the mirror surface at the first point, and is a function of the zenith angle θ and the elevation angle μ(θ) as the following Equation 6.
$$ϕ ( θ ) = \frac{θ + \frac{π}{2} - ψ - μ ( θ )}{2} \qquad ( Equation 6 )$$

3-4. (canceled)

5. A complex mirror, comprising:
a first mirror surface and a second mirror surface respectively having a rotationally symmetric profile about the z-axis in a spherical coordinate, wherein the z-axis has zero zenith angle, and
the profile of the first mirror surface is described with a set of coordinate pairs (θ_{I}, r_{I}(θ_{I})) in the spherical coordinate, θ_{I} is the zenith angle of a first reflected ray reflected at a first point on the first mirror surface and passing through the origin of the spherical coordinate, the zenith angle θ_{I} ranges from zero to a maximum zenith angle θ_{I2} less than π/2 (0≦θ_{I}<θ_{I2}<π/2), and r_{I}(θ_{I}) is the corresponding distance from the origin of the spherical coordinate to the first point on the first mirror surface and satisfies the following Equation 23:
$${r}_{I} ( {θ}_{I} ) = {r}_{I} ( 0 ) exp [ {\int }_{0}^{{θ}_{I}} \frac{sin {θ}^{′} + cot ϕ ( {θ}^{′} ) cos {θ}^{′}}{cos {θ}^{′} - cot ϕ ( {θ}^{′} ) sin {θ}^{′}} ⅆ {θ}^{′} ] \qquad ( Equation 23 )$$
where r_{I}(0) is the corresponding distance from the origin to the intersection between the first mirror surface and the z-axis,
the first reflected ray is formed by a first incident ray having a nadir angle δ_{I} ranging from zero to a maximum nadir angle δ_{I2} less than π/2 (0≦δ_{I}≦δ_{I2}<π/2), the nadir angle δ_{I} is a function of the zenith angle θ_{I} having a maximum zenith angle θ_{I2} less than the maximum nadir angle δ_{I2}(0<θ_{I2}<δ_{I2}≦π/2), and satisfies the following Equation 24:
$${δ}_{I} ( {θ}_{I} ) = {tan}^{- 1} ( \frac{tan {δ}_{I 2}}{tan {θ}_{I 2}} tan {θ}_{I} ) \qquad ( Equation 24 )$$
φ_{I}(θ_{I}) is the angle subtended by the z-axis and the first tangent plane to the first mirror surface at the first point, and is a function of θ_{I} and δ_{I}(θ_{I}) as the following Equation 25:
$${ϕ}_{I} ( {θ}_{I} ) = \frac{{θ}_{I} + ( π \pm {δ}_{I} )}{2} \qquad ( Equation 25 )$$
the profile of the second mirror surface is described with a set of coordinate pairs (θ_{O}, r_{O}(θ_{O})) in the spherical coordinate, θ_{O} is the zenith angle of a second reflected ray reflected at a second point on the second mirror surface and passing through the origin of the spherical coordinate, the zenith angle θ_{O} ranges from a minimum zenith angle θ_{O1} no less than θ_{I2} to a maximum zenith angle θ_{O2} less than π/2 (θ_{I2}≦θ_{O1}≦θ_{O}≦θ_{O2}<π/2), and r_{O}(θ_{O}) is the corresponding distance from the origin of the spherical coordinate to the second point on the second mirror surface and satisfies the following Equation 26:
$${r}_{o} ( {θ}_{o} ) = {r}_{0} ( {θ}_{oi} ) exp [ {\int }_{{θ}_{oi}}^{{θ}_{o}} \frac{sin {θ}^{′} + cot {ϕ}_{o} ( {θ}^{′} ) cos {θ}^{′}}{cos {θ}^{′} - cot {ϕ}_{o} ( {θ}^{′} ) sin {θ}^{′}} ⅆ {θ}^{′} ] \qquad ( Equation 26 )$$
where θ_{Oi} is the zenith angle of a third reflected ray reflected at a third point on the second mirror surface and passing through the origin of the spherical coordinate, and r_{O}(θ_{Oi}) is the corresponding distance from the origin to the third point,
a normal drawn from the second point to a cone compassing both the first and the second mirror surfaces and having the rotational symmetry axis coinciding with the z-axis has an altitude angle ψ, the altitude angle ψ is measured from the plane perpendicular to the z-axis (i.e., the x-y plane) toward the zenith, the second reflected ray is formed by a second incident ray having an elevation angle μₒ, the elevation angle μₒ is measured from the normal to the incident ray in the same direction as the altitude angle ψ and ranges from a minimum elevation angle μ_{O1} larger than −π/2 to a maximum elevation angle μ_{O2} less than π/2 (−π/2<μ_{O1}≦μ_{O}≦μ_{O2}<π/2), and the elevation angle μ_{O} is a function of the zenith angle θ_{O} as the following Equation 27:
$${μ}_{O} ( {θ}_{O} ) = {tan}^{- 1} [ \frac{tan {μ}_{O 2} - tan {μ}_{O 1}}{tan {θ}_{O 2} - tan {θ}_{O 1}} ( tan {θ}_{O} - tan {θ}_{O 1} ) + tan {μ}_{O 1} ] \qquad ( Equation 27 )$$
and φ_{O}(θ_{O}) is the angle subtended by the z-axis and the second tangent plane to the second mirror surface at the second point, and is a function of the zenith angle θ_{O} and the elevation angle μ_{O}(θ_{O}) as the following Equation 28.
$${ϕ}_{o} ( {θ}_{o} ) = \frac{{θ}_{o} + \frac{π}{2} - ψ - {μ}_{o} ( {θ}_{o} )}{2} \qquad ( Equation 28 )$$

6-26. (canceled)
